(19) United States
(12) Patent Application Publication
(10) Pub. No.: US 2026/0001666 A1
(43) Pub. Date: Jan. 1, 2026

(54) AUTONOMOUS MULTIFUNCTIONAL INSPECTION AND RESCUE QUADCOPTER DRONE SYSTEM

(71) Applicant: Ibrahim M. ALARIFI, Majmaah (SA)

(72) Inventor: Ibrahim M. ALARIFI, Majmaah (SA)

(21) Appl. No.: 19/320,541

(22) Filed: Sep. 5, 2025

(51) Int. Cl. B64U 10/14; B64C 1/08; B64C 25/54; B64U 20/30; B64U 20/65; B64U 20/70; B64U 20/87; B64U 50/30

(52) U.S. Cl. CPC B64U 10/14; B64C 25/54; B64U 20/30; B64U 20/65; B64U 20/70; B64U 20/87; B64U 50/30; B64C 1/08

(57) ABSTRACT

The present invention relates to an autonomous multifunctional inspection and rescue quadcopter drone system. The proposed drone system features an adaptive design for operation in multiple environments, wherein the system employs robust carob fiber frame, with a top protective cage, a bottom floats for water landing and floating capability, and advanced sensor suits, and artificial intelligence capabilities, wherein the advance sensor suits include LiDAR, thermal camera, and RGB camera, and wherein the AI capabilities allow the drone to performing autonomous navigation, and fault detection, which significantly enhance efficiency and safety in inspection and rescue operations. The proposed drone system has reduced operational costs and complexity, enhanced safety and reliability during inspections, and faster and more effective emergency response capabilities.

### FIELD OF THE INVENTION

The present disclosure relates to the field of unmanned aerial vehicles (UAVs), particularly to an autonomous multifunctional inspection and rescue quadcopter drone system, and a method thereof. In more particular manner the present invention relates to a highly versatile autonomous drone system featuring adaptive design for operation in multiple environments, such as industrial inspection, search and rescue, and environmental monitoring.

### BACKGROUND OF THE INVENTION

For performing operations across different environments such as, indoor, outdoor, and aquatic, there is a requirement of specialized drone system. The existing inspection drone lack the comprehensive versatility, wherein the existing drones do not provide robust collision protection, capability of landing or floating on water, and advance autonomous navigation and real-time data analytics.

In various prior arts, the drone has several drawbacks, such as: limited operational versatility; lack of integrated capability for safe indoor operations and aquatic landings; insufficient autonomous obstacle avoidance and fault detection mechanisms; and high operational complexity due to multiple drone types for different environments.

Unmanned aerial vehicles are now widely used for inspection, surveillance, mapping, and rescue missions. Conventional designs prioritize lightweight construction and propulsion efficiency, but they suffer from significant shortcomings when subjected to collisions, environmental exposure, or unexpected landings. One persistent limitation in existing drones is the lack of robust propeller and motor protection. Although some UAVs employ protective frames or cages, such structures are often rigidly fastened to the arms of the frame. As a result, impact forces encountered during indoor navigation or close-proximity flight are transmitted directly to the motor mounts and arm junctions, causing permanent deformation or failure. The absence of energy-dissipating interfaces between the cage and the structural arms makes conventional protective solutions ineffective against repeated impacts.

Another difficulty arises when UAVs are required to operate near or above water bodies. Most conventional drones are incapable of landing on water, and any accidental immersion causes loss of stability and damage to electronic modules. Attempts to equip drones with pontoons or detachable flotation units have resulted in increased aerodynamic drag and reduced maneuverability, while also requiring reconfiguration before aquatic operations. Thus, known designs fail to achieve a practical system that seamlessly transitions from aerial operation to stable aquatic flotation without altering the configuration.

Furthermore, wiring management in conventional UAVs is generally external, with motor phase wires strapped along the outer surfaces of the arms. This arrangement exposes electrical connections to mechanical abrasion, fatigue due to vibration, and ingress of moisture. Such routing not only reduces reliability but also compromises aerodynamics. Similarly, battery retention methods often rely on straps or external clamps, which provide insufficient protection against inertial forces. During abrupt deceleration or emergency landings, batteries can become displaced or disconnected, jeopardizing system safety.

Vibration interference is also a persistent challenge in UAV operation. Sensitive components such as flight controllers rely on inertial sensors to maintain stable flight dynamics. In many existing drones, these modules are mounted rigidly within the central frame, making them highly susceptible to oscillatory disturbances transmitted by motors and propellers. Although some damping pads have been employed, they generally lack preloading or structural integration, and therefore cannot effectively isolate the flight controller from frame-borne vibrations.

In addition, drones increasingly integrate advanced payloads such as thermal cameras, pilot cameras, RGB cameras, LiDAR sensors, and flight computers. In conventional practice, these modules are often mounted externally or in ad hoc fashion, without robust mechanical integration into the load-bearing structure of the frame. Such arrangements expose the components to misalignment, vibration-induced noise, and direct impact damage. In particular, LiDAR modules require mechanical stability to maintain scanning accuracy, and flight computers require effective thermal and structural support for reliable operation. Existing UAV frameworks fail to provide unified mechanical integration of these modules while maintaining environmental resilience.

Accordingly, there exists a need for an unmanned aerial vehicle system that combines a collision-absorbing protective cage with elastic mounting interfaces, a flotation system integrated into the frame by keyed dovetail and locking members to provide stable aquatic landings, sealed conduits within the arms for protected wire routing, and a reinforced battery bay with guiding rails and locking detents to secure the power supply under inertial loads.

In the view of the foregoing discussion, it is clearly portrayed that there is a need for an advanced and specialized drone system, and for that, the present invention provides an advance autonomous drone system for industrial inspection, search and rescue, and environmental monitoring, wherein the drone features an adaptive design for operation in multiple environments.

### SUMMARY OF THE INVENTION

The present disclosure relates to an autonomous multifunctional inspection and rescue quadcopter drone system, and a method thereof. The drone system employs a robust carbon filter structure with protective cage and floats, advanced sensor suits, and an AI-driver navigation, and fault detection capabilities, significantly enhancing efficiency and safety in inspection and rescue operations. The system integrates robust versatility by incorporating carbon fiber protective cages for safe indoor operations, integrated floats for water landing and floating capability, and advanced onboard sensors (LiDAR, thermal and RGB cameras) with AI-based processing through Jetson Orin Nano. This significantly reduces operational complexity and enhances capability in diverse environments.

The present disclosure seeks to provide an autonomous multifunctional inspection and rescue quadcopter drone system. The system comprises a carbon fiber frame for providing structural support and durability for aerial operations; a plurality of propellers attached to the carbon fiber frame; a plurality of motors configured to drive the propellers for flight operations; a plurality of electronic speed controllers configured to manage power delivery to the motors; a protective cage enclosing the propellers, and protecting the propellers and critical components during indoor navigation; a plurality of lightweight floats attached symmetrically to a lower portion of the carbon fiber frame, wherein the lightweight floats are configured to enable the drone to land safely and float stably on water surfaces; a flight controller configured to manage flight dynamics, stabilization, autopilot features, GPS navigation, and communicate telemetry data to a ground station, wherein the flight controller enable price control and monitoring of the drone operation, and also facilitates the data communication between components; a flight computer comprising a processor configured to execute artificial intelligence algorithms for autonomous obstacle avoidance, environmental mapping, and fault detection, wherein the flight computer is further configured to process real-time data; a LiDAR sensor positioned on top of the drone and configured to provide 360-degree 3D mapping of surroundings and precise distance measurements to obstacles; a thermal camera configured to identify thermal anomalies including human presence, gas leaks, and heat signatures; a pilot camera configured to provide real-time visual feed for manual control and navigation; an RGB camera configured to capture high-resolution images for detailed inspection and onboard AI processing; a power system configured to supply electrical power to all components of the drone; and a telemetry receiver configured to enable real-time communication and data transmission between the drone and the ground station.

The present disclosure also seeks to provide a method for autonomous multifunctional inspection and rescue operations using the drone system. The method comprises: initializing the drone system by powering up onboard electronics and performing automatic pre-flight diagnostics; configuring a mission via the ground station; executing autonomous flight following predefined flight paths or manual commands; acquiring real-time data through the LiDAR sensor, thermal camera, and RGB camera during flight, wherein the collected data is utilized for immediate processing and actionable intelligence; processing the acquired data onboard using artificial intelligence algorithms executed by the flight computer, wherein the flight controller and flight computer continuously communicate with each other to adjust flight dynamics, based on the environmental conditions and sensor feedbacks, wherein the flight computer enables automatic identification of obstacles, anomalies, structural issues, or thermal variations indicative of hazards or human presence; autonomously detecting and avoiding obstacles using LiDAR-generated 3D mapping and AI-driven image recognition, enabling to drone to adjust the flight path dynamically; and transmitting live telemetry and sensor data to the ground station for real-time decision-making.

An object of the present disclosure is to provide an autonomous multifunctional inspection and rescue quadcopter drone system, wherein the system can perform multifunctional operations such as, industrial inspection, search and rescue, and environmental monitoring.

Another object of the present disclosure is to provide a method for autonomous multifunctional inspection and rescue operations using the drone system.

Another object of the present disclosure is to provide a single drone system that is capable of indoor, outdoor, and aquatic inspections.

Another object of the present disclosure is to provide a drone system configured to perform real-time thermal imaging and advanced 3D mapping.

Another object of the present disclosure is to provide a drone system configured to utilize artificial intelligence for real-time autonomous navigation, fault detection, and obstacle avoidance.

Yet, another object of the present disclosure is to provide a drone system with a design ensuring safety of the components of the done, wherein the system includes a protective cage on top, and floats at the bottom for enabling water floating capabilities.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of an autonomous multifunctional inspection and rescue quadcopter drone system, in accordance with an embodiment of the present disclosure;

FIG. 2 illustrates a flow chart of a method for autonomous multifunctional inspection and rescue operations using the drone system, in accordance with an embodiment of the present disclosure;

FIG. 3 illustrates a perspective view of the proposed drone system, in accordance with an embodiment of the present disclosure;

FIG. 4 illustrates a front view of the proposed drone system, in accordance with an embodiment of the present disclosure;

FIG. 5 illustrates the back view of the proposed drone system, in accordance with an embodiment of the present disclosure;

FIG. 6 illustrates the side view of the proposed drone system, in accordance with an embodiment of the present disclosure;

FIG. 7 illustrates the bottom view of the proposed drone system, in accordance with an embodiment of the present disclosure;

FIG. 8 illustrates the top view of the proposed drone system, in accordance with an embodiment of the present disclosure;

FIG. 9 illustrates the compressive overview of the proposed drone system, in accordance with an embodiment of the present disclosure; and

FIG. 10 illustrates the architectural overview of the proposed drone system, in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

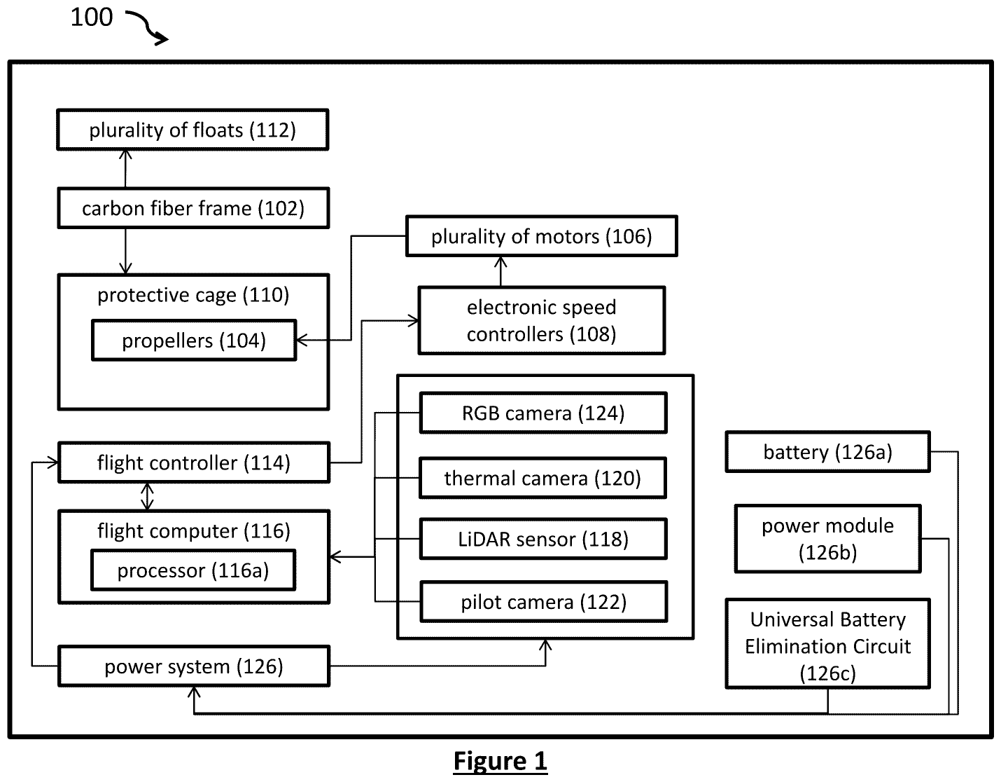

FIG. 1 illustrates a block diagram of an autonomous multifunctional inspection and rescue quadcopter drone system (100), in accordance with an embodiment of the present disclosure. The drone system (100), comprising: a carbon fiber frame (102) having a central body portion and a plurality of radially extending hollow arms, each hollow arm terminating in a distal motor mount platform;
a plurality of motors (106) each mounted on a respective distal motor mount platform;
a protective cage (110) formed of arcuate struts joined at geodesic nodes, the protective cage (110) surrounding a plurality of propellers (104) and the motors (106), each motor (106) driving a corresponding propeller (104), and each geodesic node being received in a socket at a distal end of a corresponding hollow arm, and an elastomeric interface positioned between the geodesic nodes and the socket to absorb collision forces transmitted through the protective cage (110); and
a plurality of floats (112) attached to a lower portion of the carbon fiber frame (102), each floats (112) being secured by a keyed engagement into a recess of the carbon fiber frame (102) and locked by a transverse retention member, the floats (112) being symmetrically arranged relative to the carbon fiber frame (102) such that a center of buoyancy of the drone system (100) is aligned with a center of gravity, and wherein a lowest portion of the protective cage (110) is elevated above an upper surface of the floats (112) so that the propellers (104) remain clear of water when the drone system (100) is floating;
wherein each socket at the distal end of the hollow arm includes an annular seat lined with a compressible elastomer bushing, the geodesic nodes of the protective cage (110) being partially embedded in the annular seat, and a transverse pin passing through aligned bores in a distal arm and the geodesic nodes, whereby the protective cage (110) is restrained against axial withdrawal while being permitted limited angular displacement relative to the hollow arm under lateral impact; and wherein each floats (112) includes a rigid insert integrally molded within the float, the rigid insert being shaped as a trapezoidal dovetail projection received in a complementary dovetail recess of the carbon fiber frame (102), the recess being oriented such that vertical pull-out and rotational twisting of the floats (112) are mechanically prevented, and wherein a locking pin inserted transversely through the trapezoidal dovetail projection and a recess wall secures the floats (112) in place; and wherein the floats (112) extend below the lower surface of the carbon fiber frame (102) such that, when the drone system (100) is resting on a planar ground surface, the floats (112) act as landing supports and the protective cage (110) is elevated above the planar ground surface, thereby preventing contact of the propellers (104) with the planar ground surface during take-off and landing operations.

In this primary embodiment, the drone system (100) is conceived as a multi-environment aerial vehicle that integrates advanced structural, protective, and flotation features into a single cohesive design. At its core is the carbon fiber frame (102), engineered with a central body portion and a plurality of radially extending hollow arms, each terminating in a distal motor mount platform. Carbon fiber is selected for its high strength-to-weight ratio, torsional stiffness, and resistance to fatigue, ensuring that the frame can simultaneously withstand the thrust loads generated by the motors (106) while keeping overall system weight low for extended endurance.

Mounted at the distal platforms are the motors (106), each driving a propeller (104). The distributed arrangement of motors around the frame provides lift and directional control, but also imposes torsional and bending moments on the hollow arms. The hollow configuration of the arms is exploited not only to resist these loads but also to serve as internal conduits for motor phase wiring, thereby eliminating the need for exposed cabling and ensuring both aerodynamic efficiency and environmental protection.

Surrounding the propellers and motors is a protective cage (110), which is formed from a network of arcuate struts intersecting at geodesic nodes. This cage provides 360-degree collision protection against obstacles, debris, and unintended contact during operation in confined or cluttered environments. Each geodesic node is mechanically seated into a socket at the distal end of a hollow arm, where it engages with an elastomeric interface. The elastomer absorbs and dissipates impact forces, preventing brittle fracture of the frame, while a transverse pin passing through aligned bores in both the node and the socket restrains the cage against axial withdrawal. Importantly, this pin and elastomer interface allow limited angular displacement of the cage relative to the arm under lateral impacts, enabling the cage to function as a sacrificial, energy-absorbing barrier rather than a rigid load transmitter.

The floats (112) are mounted beneath the carbon fiber frame, ensuring the drone is equally capable of aquatic operations. Each float includes a rigid insert molded into its body, shaped as a trapezoidal dovetail projection that locks into a complementary recess in the frame. This dovetail geometry mechanically prevents vertical pull-out or rotational twisting of the floats under buoyant or hydrodynamic loading. A transverse locking pin further secures each float, ensuring long-term operational integrity even under repeated aquatic impacts. The floats are symmetrically arranged relative to the central frame, such that the center of buoyancy is aligned with the center of gravity of the drone. This precise alignment allows the drone to float stably and upright, minimizing the risk of capsizing. Critically, the floats are dimensioned to extend below the lower surface of the frame, so they also serve as landing supports during ground operations. This means that when the drone rests on a planar ground surface, the protective cage (110) is elevated, ensuring that the propellers (104) remain clear of both the ground and potential debris during take-off and landing. The technical effect of this embodiment is the achievement of a drone architecture that is simultaneously collision-resistant, amphibious, and structurally integrated. The protective cage safeguards propellers while allowing controlled compliance under impact, the dovetail-secured floats provide stable flotation while doubling as ground landing gear, and the hollow carbon fiber arms deliver both structural stiffness and protected electrical routing. Together, these features create a drone that can reliably operate in multi-modal environments-indoors, outdoors, over land, and on water-without requiring add-on accessories or separate landing systems.

The technical advancement over conventional drone systems lies in the integration of modular sacrificial protection, keyed flotation assemblies, and dual-purpose structural elements into a lightweight carbon fiber framework. Whereas typical drones rely on detachable pontoons, external skids, or fragile propeller guards, this embodiment unifies these subsystems into a robust, self-contained platform. This not only reduces weight and complexity but also improves resilience, operational uptime, and mission versatility.

A practical example highlights the efficacy: in a coastal monitoring mission, the drone takes off from a concrete surface, with the floats acting as skids to stabilize take-off. While flying at low altitude near a pier, the cage absorbs a glancing collision with a pole, deflecting without transmitting damage to the arms. The drone then lands directly on open water, where the floats maintain upright stability and ensure that the cage remains above the waterline, keeping propellers clear for relaunch. This seamless transition across environments demonstrates technical efficacy by extending the operational envelope of the drone beyond what conventional designs can achieve.

In an embodiment, each hollow arm of the carbon fiber frame (102) defines an internal conduit for routing motor phase wires, the conduit terminating in a sealed outlet adjacent the distal motor mount platform, the sealed outlet including an elastomeric grommet compressed into a chamfered aperture of the outlet, the grommet gripping the wires to provide strain relief and forming a seal to prevent moisture ingress during aquatic operation; and wherein the carbon fiber frame (102) defines a battery bay in the central body portion, the battery bay comprising parallel guiding rails integrally bonded to a lower plate of the carbon fiber frame (102), the guiding rails engaging complementary ridges on a casing of a battery (126a) to prevent lateral movement, and a spring-biased detent engaging a recess in the casing of the battery (126a) to positively restrain the battery against inertial ejection forces.

In this embodiment, the structural and functional design of the carbon fiber frame is exploited not only for mechanical load-bearing but also for integrated electrical and energy management pathways. Each hollow arm of the frame is engineered with an internal conduit, essentially a longitudinal channel within the carbon fiber laminate, through which the motor phase wires are routed. Unlike conventional drones where wiring is externally clipped along arms and thus exposed to environmental damage, the wires here are completely embedded within the arm, yielding two distinct technical effects: first, reduction in aerodynamic drag by eliminating protrusions from the drone's body, and second, enhanced protection against mechanical abrasion, torsional stress, and water ingress. At the distal motor mount platform, the conduit terminates in a sealed outlet, which is precision-machined with a chamfered aperture. Into this aperture is inserted an elastomeric grommet that is compressed during assembly to grip the wires firmly. The grommet performs dual roles: it provides strain relief so that vibrations or tugs on the wires are not transmitted directly to solder joints at the motor terminals, and it forms a watertight barrier that prevents moisture entry during aquatic operation. For example, when the drone is deployed in maritime surveillance and splashes from waves strike the arms, the grommet maintains electrical integrity by preventing water penetration into the hollow arm cavity.

In addition to electrical routing, the central body portion of the frame is designed with a battery bay that ensures secure, repeatable, and crash-resistant installation of the drone's power source. The bay is constructed with parallel guiding rails integrally bonded to the lower plate of the frame. These rails mate with complementary ridges on the casing of the battery, effectively preventing lateral sliding or vertical wobble during flight maneuvers that generate inertial loads. Once the battery is inserted, a spring-biased detent automatically engages with a corresponding recess in the battery casing. This detent creates a positive locking mechanism that resists inertial ejection forces. In practical terms, when the drone performs rapid deceleration or emergency maneuvers—such as sudden braking after high-speed flight—the detent ensures that the battery cannot dislodge, a failure mode observed in drones with friction-only retention.

The technical advancement of this embodiment is the integration of wire management and power source stabilization directly into the structural frame, reducing the number of ancillary brackets, harnesses, or external housings typically used in conventional drones. This results in a lighter, cleaner, and more robust architecture. The combination of elastomeric sealing and strain relief at the conduit outlet specifically enables dual-environment operation, meaning the drone can land on water without risk of short-circuiting. The secure battery bay further ensures operational continuity and safety, as inadvertent power loss due to battery displacement is mechanically prevented even in turbulent conditions.

Taken together, this embodiment demonstrates a high degree of technical efficacy: the drone remains structurally rigid, electrically sealed, and power-secure during both aerial and aquatic operations, thereby advancing drone design beyond the current art of external cable management and simple Velcro battery straps.

In an embodiment, the protective cage (110) is mechanically removable by withdrawal of the transverse pins from the sockets at the distal arms, such that the protective cage (110) can be replaced as a sacrificial component without detaching the motors (106) or floats (112); and wherein the floats (112) are arranged along both lateral sides of the carbon fiber frame (102) such that the buoyancy forces generated by the floats (112) maintain the drone system (100) in an upright orientation on water, and wherein displacement of the drone system (100) from upright position results in self-righting due to realignment of the buoyant centerline with the center of gravity of the drone system (100).

In this embodiment, the design of the drone system is focused on maintainability, modularity, and aquatic stability. The protective cage (110), which encloses the motors and propellers, is not permanently fixed but instead mechanically retained by transverse pins inserted through aligned bores in the sockets at the distal ends of the hollow arms. By simply withdrawing these pins, the cage can be disengaged from the arms without disturbing the motors or floats. This mechanical removability transforms the cage into a sacrificial component that absorbs impact forces during collisions and, once deformed or fatigued, can be quickly replaced without requiring disassembly of propulsion or flotation subsystems. For instance, if the drone collides with a tree canopy during a reconnaissance flight, the cage struts may be damaged, but the rapid replacement mechanism allows a field operator to restore operational readiness in minutes, unlike conventional drones where damage to fixed guards often requires full disassembly and re-wiring.

The second part of this embodiment addresses aquatic stability and self-righting behavior. The floats (112) are strategically positioned along the lateral sides of the carbon fiber frame so that their buoyant forces act symmetrically relative to the drone's vertical centerline. This ensures that when the drone lands on water, the combined buoyancy vector aligns naturally with the center of gravity, keeping the system upright. If the drone is displaced from this upright orientation—for example, by a side wave or wind-induced tilting—the asymmetric immersion of the floats shifts the buoyant centerline away from the displaced angle. As buoyancy always acts vertically upward, this shift generates a restoring torque that rotates the drone back into alignment with its center of gravity. This process constitutes a self-righting mechanism that is entirely passive, requiring no active thrust correction by the motors.

The technical effect of this embodiment is twofold. First, the removable cage offers a field-serviceable collision management system: instead of treating protective structures as permanent, the cage functions like a replaceable bumper, minimizing downtime and extending drone service life. Second, the float arrangement provides automatic self-righting stability on water, eliminating the need for complex gyroscopic recovery algorithms or additional actuators. The result is a drone that not only survives harsh environments but also autonomously maintains operability in dual media—air and water—with minimal human intervention.

The technical advancement over conventional drones lies in this combination of modular sacrificial protection and passive self-righting flotation. Current drones either lack protective cages altogether, or use cages that are permanently bonded and difficult to replace, and they rarely include floats capable of autonomously restoring upright stability on water. By integrating these elements, the present system advances the state of the art by enabling both cost-efficient maintenance and robust aquatic survivability, which are critical for maritime surveillance, search-and-rescue, and offshore inspection missions.

In an embodiment, the central body portion of the carbon fiber frame (102) houses a flight controller (114) mounted on elastomeric suspension posts, the suspension posts being preloaded in compression such that oscillations transmitted from the motors (106) and propellers (104) through the carbon fiber frame (102) are attenuated before reaching inertial sensors of the flight controller (114); and wherein the protective cage (110) and the floats (112) are positioned relative to each other such that, when the drone system (100) floats on water, the protective cage (110) remains clear of the waterline while continuing to enclose the propellers (104), thereby maintaining both collision protection and aquatic stability in a single integrated structure.

In this embodiment, the central body portion of the carbon fiber frame (102) is engineered not merely as a structural hub, but as a housing that ensures stable operation of sensitive electronics under conditions of mechanical vibration and environmental disturbance. A flight controller (114) is mounted within the central body on elastomeric suspension posts. These posts are preloaded in compression during assembly so that the elastomeric material is already engaged against the mounting surfaces, ensuring there are no gaps or looseness that could allow the controller to rattle. This preload condition enables the suspension posts to absorb vibrational energy immediately through shear and compression deformation of the elastomer, attenuating oscillations that originate from the motors (106) and propellers (104). In practice, propeller-induced vibrations typically occur at high frequencies associated with rotational speeds, and without isolation they can couple into the inertial sensors of the flight controller, leading to erroneous readings and unstable flight control loops. By decoupling the controller from the structural frame, this embodiment ensures that sensor data remains accurate, improving flight stability and reducing control latency.

A practical example is when the drone operates at high thrust levels, such as in vertical takeoff with heavy payloads. The torsional loads in the carbon fiber arms can induce micro-vibrations across the frame. In a conventional rigid-mounted flight controller, accelerometer and gyroscope readings may exhibit noise spikes, forcing the control algorithm to filter aggressively, which increases response lag. Here, the elastomeric suspension isolates the flight controller from the noise at the mechanical level, resulting in cleaner sensor signals and a more responsive control system, yielding better stability in turbulent air or gusty environments.

The embodiment also extends this precision to aquatic operation. The protective cage (110) and floats (112) are arranged relative to each other so that, when the drone lands on water, the cage continues to encircle the propellers while remaining elevated above the waterline. This dual-purpose arrangement is significant: the cage maintains its function as a collision barrier, preventing debris, floating objects, or waves from contacting the spinning propellers, while the floats provide the primary buoyancy and stability. The integrated positioning ensures that the drone is not only protected in air but also when floating in water, with no compromise in either mode.

The technical effect of this embodiment is the combination of precision flight control stability through vibration isolation and dual-medium operability through integrated positioning of cage and floats. The suspension mounting directly enhances the performance of inertial sensors, leading to improved flight accuracy and reduced risk of instability. Simultaneously, the cage-float arrangement guarantees that when operating in aquatic environments, the drone remains both buoyant and safeguarded against water-induced hazards, without requiring additional deployable structures.

The technical advancement over conventional drones is evident in two ways. First, while existing drones may use simple foam pads or rubber washers for controller isolation, these do not provide controlled preload or predictable damping across multiple vibration modes. The use of preloaded elastomeric suspension posts achieves superior, tunable damping performance. Second, the coordinated positioning of the protective cage and floats provides an integrated solution for aerial-aquatic stability and safety, eliminating the need for separate landing gear for land, propeller guards for air, and pontoons for water. This structural integration leads to a lighter, more efficient, and multifunctional design.

In an embodiment, the protective cage (110) comprises arcuate struts intersecting at geodesic junctions, each junction including keyed interfaces between the struts to prevent relative slippage under compressive impact loads, thereby preserving the geometric integrity of the cage (110) as an energy-dissipating structure; and wherein the arcuate struts of the protective cage (110) intersect at the geodesic junctions with complementary keyed ends, and wherein adhesive bonding or mechanical fastening at the keyed ends resists both axial separation and torsional twisting of the struts relative to one another, thereby preserving the spherical geometry of the protective cage (110) even after repeated impact events.

In this embodiment, the protective cage (110) is engineered as a geodesic lattice structure designed not only to shield the propellers (104) and motors (106) from impact but also to act as a controlled energy-dissipating shell that maintains integrity under repeated collisions. The cage is composed of arcuate struts that intersect at geodesic junctions. Each junction incorporates keyed interfaces—mechanical interlocks formed at the ends of the struts—that ensure the struts cannot slip relative to one another when subjected to compressive impact forces. For example, a keyed tongue-and-groove geometry or a trapezoidal notch at the strut ends forces the load path to transfer directly across interlocking surfaces rather than relying solely on adhesive or friction. This prevents the junctions from deforming under load and ensures that the geodesic form remains intact even during high-energy collisions.

To further secure the structure, the complementary keyed ends of the struts are fixed using either adhesive bonding or mechanical fastening (such as pins or screws passing through the keyed interfaces). The combination of keyed geometry with bonding or fastening prevents both axial separation (the struts pulling apart under tensile or compressive forces) and torsional twisting (relative rotation of the struts around the junction). This ensures that the cage preserves its spherical geometry throughout repeated impact cycles. In practical operation, when the drone collides with an obstacle such as a wall, pole, or tree branch, the arcuate struts elastically deform and then redistribute the load across the cage's geodesic network. The forces are not localized at a single point but spread across multiple struts and junctions, dissipating the energy effectively and reducing the likelihood of catastrophic structural collapse.

The technical effect of this embodiment is the creation of a durable, load-dissipating impact barrier that retains its protective function over multiple collisions. Unlike conventional propeller guards, which are often formed of thin rings or open plastic frames prone to snapping under repeated stress, the geodesic cage with keyed junctions offers multi-directional resistance to impact forces. This ensures that even after repeated encounters with obstacles, the drone's protective geometry remains largely preserved, maintaining continuous operational safety for both the drone and its surroundings.

The technical advancement achieved lies in the integration of keyed geodesic junctions with structural bonding or fastening. Conventional spherical cages, when they exist, often rely on frictional or welded connections that degrade quickly after impacts, leading to progressive weakening and eventual collapse. By contrast, the present design leverages mechanical interlocking geometries that inherently resist slippage and twisting, supplemented with bonding or fastening for redundancy. This provides predictable, repeatable impact performance, enabling the cage to serve as a semi-sacrificial but reusable energy absorber rather than a single-use guard.

An example scenario illustrates the efficacy: when the drone strikes a tree branch during a forest inspection mission, the impact energy is absorbed and spread across multiple struts through the geodesic network. The keyed junctions ensure that none of the struts shear out of place or rotate under load, preserving the spherical enclosure and allowing the drone to continue flying with no immediate need for repair. Thus, the embodiment demonstrates not only enhanced operational robustness but also reduced maintenance burden and extended service life of the protective structure.

In an embodiment, the sockets formed at the distal ends of the hollow arms include opposed internal shoulders that laterally confine the geodesic nodes of the protective cage (110), and wherein the elastomeric bushing positioned between the geodesic node and the socket wall deforms radially upon impact, thereby permitting the protective cage (110) to shift minutely relative to the hollow arm while the opposed shoulders mechanically restrain the geodesic node against circumferential displacement; and wherein each transverse pin securing the geodesic node within the socket is received in a through-bore of the geodesic node and a corresponding pair of aligned bores in the socket wall, and wherein the transverse pin is axially retained by frictional engagement with the socket wall, thereby enabling the transverse pin to serve both as a shear-resisting element locking the protective cage (110) to the hollow arm and as a pivot axis allowing limited angular articulation of the geodesic nodes within the elastomeric interface.

In this embodiment, the junction between the hollow arms of the carbon fiber frame (102) and the protective cage (110) is designed as a mechanically compliant yet structurally restrained coupling that balances rigidity with controlled flexibility under impact. At the distal ends of the hollow arms, sockets are formed with opposed internal shoulders that receive the geodesic nodes of the cage. These shoulders serve as lateral stops that prevent the node from shifting circumferentially within the socket, thereby maintaining precise alignment of the cage relative to the arms. At the same time, an elastomeric bushing is positioned between the socket wall and the surface of the geodesic node. When an impact force acts on the cage, the bushing undergoes radial deformation, compressing and absorbing part of the impact energy. This deformation allows the cage to shift minutely relative to the arm, effectively decoupling the cage from rigid contact with the frame and reducing the transmission of peak impact loads into the carbon fiber arms.

The transverse pin plays a dual mechanical role. It passes through a through-bore in the geodesic node and aligns with bores in the socket wall, locking the node into the socket. The pin is retained by frictional engagement with the socket wall, eliminating the need for additional locking clips or fasteners that would add weight or complexity. Functionally, this pin serves both as a shear-resisting element, preventing axial pull-out of the cage under direct loads, and as a pivot axis that allows the geodesic node to articulate slightly within the elastomeric bushing. As a result, when a lateral impact occurs—for instance, if the drone brushes against a vertical pole during inspection—the cage is permitted a small angular displacement, pivoting around the transverse pin within the cushioning elastomer. This motion dissipates impact energy while ensuring that the cage is neither rigidly locked nor entirely loose. The technical effect of this embodiment is the creation of a hybrid restraint system that provides structural integrity against major impact forces while simultaneously enabling micro-mobility of the protective cage to absorb shocks. Unlike rigid cages fixed directly to drone arms, which transmit all collision forces into the frame and risk cracking carbon fiber members, this design ensures that loads are dampened and redistributed. Furthermore, the use of the transverse pin as both a mechanical lock and pivot axis introduces multifunctionality into a single component, reducing part count and overall weight.

The technical advancement is evident when compared to conventional drone propeller guards or cages. Typical systems either rely on rigid bolted connections, which cause stress concentrations at impact points, or use flexible snap-fit joints, which can detach under load. The present embodiment overcomes these shortcomings by combining opposed shoulder confinement, elastomeric energy absorption, and pin-based articulation in a unified structure. This provides a controlled deformation pathway that protects both the drone's frame and the cage during repeated collisions.

For example, during a warehouse inspection mission, the drone may collide with shelving units or beams. With this embodiment, the cage struts deform slightly, the elastomeric bushing compresses, and the geodesic node pivots around the pin. The protective cage absorbs the brunt of the impact, but the arms remain intact, the motors continue operating, and the drone is able to resume its mission without downtime. Thus, the embodiment demonstrates superior resilience, operational continuity, and reduced maintenance overhead compared to rigid or detachable protective structures in existing drone designs.

In an embodiment, each floats (112) is keyed into its dovetail recess with surfaces inclined relative to the vertical, such that upward buoyant forces acting on the floats (112) drive the rigid insert further into the recess, thereby producing a self-locking effect that resists vertical withdrawal of the floats (112) during aquatic operation; and wherein the rigid insert of each floats (112) spans substantially across the width of the floats (112) and is encapsulated within the body of the float, and wherein the transverse locking pin passes through both the rigid insert and the opposing recess wall, such that hydrodynamic loads applied to the floats (112) are transferred directly through the rigid insert into the carbon fiber frame (102) without imposing shear stresses on the float body material.

In this embodiment, the floats (112) are not merely attached to the carbon fiber frame (102) by superficial fasteners but are instead designed with a mechanically interlocking dovetail system that exploits the very buoyant forces acting on the floats during aquatic operation to enhance attachment security. Each float includes a rigid insert molded within its body, the insert shaped as a trapezoidal dovetail projection. The recess in the carbon fiber frame is machined with complementary geometry, with its internal walls inclined relative to the vertical axis. When the float is inserted, the inclined surfaces engage, and during operation in water, the upward buoyant forces naturally act to drive the insert deeper into the recess. This produces a self-locking effect, where the higher the buoyant force, the more securely the float is retained, effectively resisting vertical pull-out.

The rigid insert itself is structurally continuous across the width of the float and completely encapsulated within the float's outer body material (such as closed-cell polymer foam). This ensures that the buoyancy-providing foam is never subjected to shear stresses that could cause tearing or detachment under hydrodynamic loading. Instead, all major loads are transmitted through the rigid insert. A transverse locking pin passes through both the rigid insert and the opposing recess wall of the frame, providing additional restraint against rotational twisting or accidental disengagement. The result is that any hydrodynamic loads-such as drag forces when the drone moves laterally in water, or oscillatory loads caused by waves are directly transferred from the float into the carbon fiber frame, which is structurally capable of bearing these forces.

The technical effect of this embodiment is the creation of a load-bearing flotation system that remains mechanically secured under both static and dynamic aquatic conditions. Unlike conventional drone pontoons or floats, which are often strapped, bolted, or glued externally, the dovetail engagement with inclined surfaces ensures that the forces of flotation themselves enhance the structural bond rather than threaten it. This prevents failure scenarios where floats detach during extended aquatic operations or when encountering wave impacts. Additionally, because the rigid insert carries the hydrodynamic loads, the buoyant foam material is free to serve its intended purpose of displacement without structural compromise.

The technical advancement lies in combining self-locking geometry with internal reinforcement and direct load transfer pathways. Conventional drones with add-on floats often rely on adhesives or external clamps, which either degrade in water or concentrate loads into localized foam regions, leading to premature float failure. The present system avoids those issues by designing the float as a composite structural component: the buoyant body provides displacement, the rigid insert provides mechanical anchoring, and the dovetail geometry ensures that forces act to strengthen rather than weaken the engagement.

As an illustrative example, during a maritime search-and-rescue mission, the drone may land repeatedly on choppy water surfaces where waves exert alternating upward and lateral forces. With this embodiment, the stronger the upward buoyant forces, the more securely the float locks into the recess, while lateral drag is resisted by the rigid insert and transverse pin transferring loads directly to the carbon fiber frame. This enables the drone to sustain repeated aquatic operations without float loosening, detachment, or degradation. Thus, the embodiment achieves long-term aquatic reliability, enhanced mechanical robustness, and operational safety that conventional drones with external pontoons cannot provide.

In an embodiment, the battery bay of the carbon fiber frame (102) is open along one lateral side of the central body portion to permit sliding insertion of the battery (126a), and wherein the guiding rails constrain the battery (126a) against vertical and lateral movement during insertion, and the spring-biased detent engages the recess in the battery casing once fully seated, thereby forming a sequential locking action that secures the battery (126a) both during flight and during water landings; and wherein the sealed outlet of the hollow arm is oriented downwardly relative to the propeller plane, and wherein the elastomeric grommet seated in the outlet forms a continuous annular seal around the motor phase wires, such that gravity assists in preventing water ingress into the hollow arm during aquatic operation of the drone system (100).

In this embodiment, the battery bay of the carbon fiber frame (102) is designed for secure, tool-free insertion and retention of the power module, while simultaneously addressing the challenges of aquatic sealing and environmental durability. The bay is deliberately open along one lateral side of the central body portion, permitting the operator to slide the battery (126a) directly into the frame rather than lowering it from above or fastening it externally. During insertion, the parallel guiding rails constrain the battery casing along its ridges, ensuring that the battery is held rigidly against both vertical and lateral displacements. This precise channeling prevents wobble or vibration that could otherwise loosen electrical contacts during flight.

Once the battery is fully inserted, a spring-biased detent engages with a pre-formed recess in the battery casing. This creates a sequential locking action: first, mechanical guidance ensures proper seating and alignment, and then the detent snaps into place to restrain the battery positively. This mechanism prevents inertial ejection forces from dislodging the battery during abrupt maneuvers, crashes, or water impacts. For instance, if the drone decelerates suddenly from forward flight to hover, or if it lands on turbulent water where vertical accelerations exceed 2-3 g, the detent resists these forces and keeps the battery firmly locked. The technical effect is a fail-safe power retention system that maintains continuous electrical supply under both aerial stresses and aquatic operations, avoiding sudden mid-air shutdowns or water-induced ejection.

The embodiment also addresses moisture protection in the wiring pathways. Each hollow arm houses internal conduits terminating at a sealed outlet near the motor mount. Crucially, the outlet is oriented downwardly relative to the propeller plane, ensuring that any incidental water droplets or spray are directed away by gravity. An elastomeric grommet is compressed into the chamfered aperture at the outlet, forming a continuous annular seal around the motor phase wires. This arrangement both grips the wires tightly, providing strain relief against vibration, and creates a watertight barrier that prevents capillary wicking of water into the hollow arm. Because of the downward orientation, any water exposure during aquatic landings drains naturally away from the conduit opening, and gravity actively assists in preventing ingress. For example, when the drone splashes down during a river inspection, droplets may reach the arm ends, but the combined effect of the downward outlet and elastomeric sealing ensures the conduits remain dry and the electrical system uncompromised.

The technical effect of this embodiment is therefore twofold: (i) a reliable and repeatable battery retention system that safeguards power integrity during both aerial shocks and aquatic forces, and (ii) a gravity-assisted sealing system for motor wiring that minimizes risk of electrical shorting in waterborne conditions.

The technical advancement over conventional drones lies in the integration of structural guidance, sequential locking, and gravity-oriented sealing into the carbon fiber frame itself. In most drones, batteries are held with straps, latches, or Velcro, which can loosen under vibration and offer limited resistance to aquatic impacts. Similarly, motor wires are often routed externally or through unsealed apertures, leaving them vulnerable to splash ingress. By contrast, this design achieves a robust, modular, and water-resistant power architecture that extends drone operability to dual-environment use.

A practical scenario highlights the efficacy: during a coastal mapping mission, the drone transitions repeatedly between aerial survey and floating deployment. Each water landing subjects the frame to buoyant jolts, yet the battery remains locked in place due to the sequential detent mechanism. Meanwhile, despite frequent spray and wave contact, the sealed grommet and downward outlets prevent any moisture intrusion into the arms, ensuring continuous motor performance. The drone thus demonstrates improved safety, higher reliability, and extended service life, advancing beyond conventional drone systems not engineered for water exposure.

In an embodiment, the floats (112) are symmetrically arranged on opposite sides of the carbon fiber frame (102) with their longitudinal axes parallel to the longitudinal axis of the frame, and wherein the buoyancy forces generated by the floats (112) are positioned equidistantly from the vertical centerline of the drone system (100), such that any roll disturbance applied during flotation is counterbalanced by equal and opposite restoring forces from the floats (112), thereby achieving self-righting stability.

In this embodiment, the floats (112) are not arbitrarily mounted but are arranged with precise geometric symmetry relative to the carbon fiber frame (102) to create a natural self-righting flotation system. Each float is positioned on an opposite lateral side of the frame, with its longitudinal axis parallel to the main longitudinal axis of the drone. This orientation ensures that the hydrodynamic resistance of the floats during water contact is consistent on both sides, avoiding drag asymmetries during aquatic landings or surface drift. More critically, the floats are located such that their centers of buoyant force are equidistant from the vertical centerline of the drone system.

When the drone is at rest on water in an upright orientation, the buoyant forces from the floats act symmetrically, perfectly counterbalancing each other. If a roll disturbance occurs—such as when a wave tips the drone to one side—the float on the submerged side displaces more water, thereby generating a greater buoyant force than its counterpart on the elevated side. This imbalance produces a restoring torque about the vertical axis that actively resists the roll and pushes the drone back toward equilibrium. Simultaneously, the elevated float provides reduced buoyancy, so the system naturally self-corrects without requiring motor intervention. For example, if the drone tips 200 to the right, the right-side float's displaced volume increases, creating an uplift force greater than that on the left side, which automatically rolls the drone back upright.

The technical effect of this arrangement is that the drone achieves self-righting stability on water passively, without the need for electronic sensors or control algorithms to correct roll imbalances. This reduces both energy consumption (since motors are not needed to stabilize the drone at rest) and system complexity, improving reliability in aquatic deployments. Even if the drone is subjected to repeated wave disturbances or wind-driven tilts, the symmetric float geometry ensures that restoring moments are always present to maintain upright flotation.

The technical advancement over conventional drones is the introduction of a geometrically balanced buoyancy system integrated with the carbon fiber frame. In typical drone designs, floats or pontoons are often attached asymmetrically or as afterthought accessories, which can result in uneven buoyancy distribution and a tendency to capsize when exposed to rolling forces. By contrast, this embodiment ensures that flotation is a primary design feature rather than an add-on, with symmetry and alignment engineered so that the drone is inherently stable on water.

As an example of practical application, during a maritime reconnaissance mission, the drone may land on open water to relay sensor data. In the presence of rolling surface waves, the drone tilts intermittently. However, the restoring buoyant forces generated by the symmetric float arrangement automatically return the drone to its upright orientation after each disturbance. This allows the drone to remain stable and functional for extended aquatic operations, providing reliable performance without active stabilization systems. Thus, the embodiment demonstrates a passive, energy-efficient, and robust self-righting mechanism, which significantly enhances operational versatility in dual aerial-aquatic environments.

In an embodiment, each elastomeric suspension post supporting the flight controller (114) is preloaded by clamping between the lower plate of the carbon fiber frame (102) and the underside of the flight controller housing, and wherein the preload ensures continuous compression of the elastomeric body, such that vibrational energy is dissipated through shear deformation of the elastomer while preventing resonant amplification of oscillations at the natural frequency of the flight controller (114).

In this embodiment, the flight controller (114) is mounted to the carbon fiber frame (102) using elastomeric suspension posts that are intentionally preloaded in compression. During assembly, each post is clamped between the lower plate of the frame and the underside of the controller housing, so that the elastomer body is always maintained under a controlled compressive state, even before the drone experiences any operational loads. This preloading condition ensures that there is no free play or looseness in the mounting, which could otherwise allow micro-gaps to develop and introduce rattle or delayed response under vibratory excitation.

The mechanical damping mechanism arises from the material properties of the elastomer. When the drone is in flight, the motors (106) and propellers (104) generate vibrations that propagate through the carbon fiber structure. Instead of being transmitted directly into the sensitive inertial sensors of the flight controller, these oscillations are absorbed by the elastomeric suspension. Under preload, the elastomer is already compressed, so further vibrations induce shear deformation within the elastomer matrix, which dissipates vibrational energy as heat. Importantly, because the elastomer is held in compression, it avoids separation or gapping under tensile or alternating loads, which would otherwise compromise damping effectiveness.

A key benefit of this arrangement is the avoidance of resonant amplification. Every rigidly mounted controller has a natural frequency; if motor vibrations align with that frequency, resonance occurs, magnifying oscillations rather than attenuating them. The preloaded elastomer posts break this feedback loop by providing broadband damping-they absorb energy across multiple frequency bands, ensuring that resonance peaks are suppressed. For example, if the drone's propellers generate oscillations at 150 Hz and 300 Hz during high-thrust maneuvers, the elastomer suspension absorbs and disperses these inputs before they distort accelerometer or gyroscope readings. The result is a cleaner signal from the inertial sensors, allowing the flight algorithms to operate on stable, accurate data.

The technical effect of this embodiment is an overall improvement in flight stability, sensor reliability, and control responsiveness. By filtering out vibrational noise mechanically, the flight controller can maintain smoother altitude hold, precise navigation, and tighter feedback control loops without relying solely on digital filtering algorithms, which add latency and computational overhead.

The technical advancement over conventional drones is the introduction of a preloaded elastomeric suspension system. While some drones use rubber pads or soft mounts for vibration isolation, these are typically not preloaded and thus can suffer from gaps, hysteresis, or ineffective damping at certain frequencies. The preload ensures constant compression, consistent damping performance, and longer material life, since elastomers under compression resist fatigue and tearing better than those subjected to tension.

A practical example illustrates the efficacy: during a survey mission in windy conditions, the motors frequently adjust RPMs, creating fluctuating vibratory inputs. In a rigid-mounted system, the flight controller would experience noisy sensor readings, causing the drone to oscillate as the controller overcorrects. With preloaded elastomeric suspension posts, the vibrations are absorbed mechanically, the inertial sensors provide stable readings, and the drone maintains smooth flight paths with less control effort. This translates directly into greater positional accuracy, reduced energy consumption, and enhanced mission reliability.

In an embodiment, the protective cage (110) and the floats (112) are cooperatively positioned such that, during a ground landing, the floats (112) act as primary contact members engaging the ground surface, while the protective cage (110) extends around the periphery of the propellers (104) without touching the ground, and wherein during aquatic operation, the floats (112) displace water to maintain the central body portion above the waterline while the protective cage (110) continues to enclose the propellers (104), thereby enabling a dual-environment landing system in which the floats (112) and protective cage (110) function together as integrated support and protection structures.

In this embodiment, the protective cage (110) and the floats (112) are not treated as independent accessories but are instead cooperatively positioned and structurally integrated so that they function as a combined dual-environment landing and protection system. During ground landings, the floats (112) are configured to extend slightly below the lower plate of the carbon fiber frame (102), acting as the primary contact members with the ground surface. This ensures that the drone rests on stable, broad bearing surfaces provided by the floats rather than on narrow arms or exposed propellers. At the same time, the protective cage (110), which fully surrounds the propellers (104), is elevated so that it never scrapes or loads against the ground.

The clearance prevents deformation of the cage during repeated take-offs and landings while ensuring that the propellers remain clear of debris, grass, or dust kicked up from the surface.

When the same drone transitions to aquatic operation, the floats (112) provide displacement buoyancy that elevates the central body portion of the frame above the waterline. This keeps all sensitive electronics—including the flight controller, battery bay, and power module—dry and protected from direct water contact. Meanwhile, the protective cage (110) continues to fully enclose the propellers even in this floating state, ensuring that the drone retains its collision protection function. The cage does not dip below the waterline, which is critical because immersion of the cage would create drag, destabilize flotation, and potentially foul the propellers. Instead, the geometry is optimized so that the cage provides continuous barrier protection while the floats alone provide buoyancy and balance.

The technical effect of this embodiment is the achievement of seamless dual-environment operability. On land, the floats serve as landing skids while the cage ensures propeller safety. On water, the floats provide flotation and stability while the cage continues to provide lateral impact protection. Importantly, both systems work together without interfering with each other: the floats prevent the cage from touching the ground or water surfaces, and the cage ensures that the propellers remain protected in all scenarios.

The technical advancement lies in the integration of two protective subsystems into a single cooperative design. Conventional drones often require separate solutions: rigid skids for ground landing, detachable pontoons for water landing, and lightweight propeller guards for collision safety. Such add-ons increase weight, complexity, and failure points. By contrast, this embodiment unifies these functions into a structurally efficient system where the cage and floats are designed together, saving weight, simplifying assembly, and improving reliability. A practical example highlights the efficacy: during a coastal reconnaissance mission, the drone lands on a concrete pier to collect data, with the floats acting as landing feet and the cage ensuring propellers remain elevated. The same drone can then take off, fly offshore, and land on the water surface to perform maritime monitoring. The floats displace sufficient volume to maintain stability even in light wave conditions, and the protective cage continues to guard against floating debris while ensuring that the propellers remain fully operational above the waterline. The operator does not need to attach or detach any additional hardware—the drone is inherently capable of both landing modes.

This embodiment thus demonstrates technical efficacy through operational versatility, ensuring that the drone remains functional, stable, and protected in both terrestrial and aquatic environments, representing a significant advancement over conventional single-environment drones.

In an embodiment, each hollow arm of the carbon fiber frame (102) simultaneously serves as a structural beam resisting torsional bending moments induced by the thrust of the motors (106) and as an enclosed conduit for routing motor phase wires, and wherein the routing of the wires within the neutral axis of the hollow arms prevents additional stress concentration on the arm wall, thereby ensuring that the arms provide both structural rigidity and electrical protection without external cabling.

In this embodiment, the hollow arms of the carbon fiber frame (102) are designed with a dual-functionality that enhances both the mechanical integrity and the electrical robustness of the drone system (100). Structurally, each hollow arm operates as a primary load-bearing beam, transmitting thrust forces and resisting torsional bending moments generated by the motors (106) and their corresponding propellers (104). When a motor spins at high RPM, the resulting thrust induces not only axial loads but also twisting moments in the arm. The carbon fiber composite construction of the hollow arms provides exceptionally high stiffness-to-weight ratio, ensuring that these torsional stresses are effectively resisted without significant deflection. This guarantees that the relative positioning of the propellers remains stable, which is critical for maintaining aerodynamic balance and flight precision.

Simultaneously, the hollow arms act as enclosed conduits for routing the motor phase wires. Rather than attaching wires externally with clips or insulation sleeves—an approach that introduces aerodynamic drag, snagging hazards, and exposure to wear—the wires are routed internally. The design is further optimized by ensuring that the wires are positioned along the neutral axis of the hollow arm. The neutral axis is the plane within the cross-section of a beam where bending stress is theoretically zero. By placing the wires here, the embodiment prevents any stress concentration from occurring at the inner walls of the arm when it bends or twists under flight loads. This prevents micro-cracking or delamination in the carbon fiber, which could occur if localized stress points were created by wire channels or cutouts.

The technical effect is a highly integrated structural-electrical system in which the arms provide both torsional rigidity for stable propulsion and mechanical shielding for the electrical wiring. Because the wiring is internal and sealed within the arm, it is protected from abrasion, water ingress, and environmental exposure, thereby reducing the risk of short circuits or mechanical fatigue. At the same time, the arm's structural efficiency is not compromised by wire routing; instead, it is actually enhanced, since the neutral-axis positioning ensures that the wires are accommodated without creating weak points in the carbon fiber walls.

The technical advancement of this embodiment lies in transforming the drone's structural members into multi-functional composite components, which combine load-bearing and electrical routing functions without trade-off. Conventional drones often treat these subsystems separately: arms provide structural support while wires are attached externally, leading to drag, vulnerability, and maintenance complications. In contrast, this integrated approach results in reduced weight, streamlined aerodynamics, and superior durability.

For example, during a long-endurance surveillance mission, the drone may operate in strong crosswinds, subjecting the arms to significant torsional bending loads. The hollow arms maintain rigidity under these loads while simultaneously protecting the motor wires from environmental stress. If the drone transitions to aquatic landing, the internal routing ensures that splashes or water spray cannot reach the wires, preserving electrical continuity. Thus, the embodiment demonstrates clear technical efficacy in providing simultaneous structural resilience and electrical protection, making the drone more robust for dual-environment operations and extending its service life under demanding conditions.

In an embodiment, the battery bay guiding rails are mechanically bonded to the upper plate and lower plate of the carbon fiber frame (102) and are further aligned parallel to the longitudinal axis of the central body portion, such that when the battery (126a) is engaged between the guiding rails, the rails and the battery casing together form a rigid cross-brace reinforcing the carbon fiber frame (102) against lateral deformation, thereby increasing torsional stiffness of the central body portion during high-thrust maneuvers.

In this embodiment, the battery bay guiding rails are not designed solely for the purpose of battery alignment and retention but are also structurally engineered to function as integral reinforcement members within the carbon fiber frame (102). These rails are mechanically bonded both to the upper plate and the lower plate of the central body portion, creating a continuous load path across the frame. Their orientation is carefully aligned parallel to the longitudinal axis of the central body portion so that, when a battery (126a) is inserted between them, the battery casing itself becomes a structural participant in the overall stiffness of the frame.

Once engaged, the combination of the guiding rails and the rigid outer casing of the battery effectively forms a cross-brace within the frame. This transforms the battery from a passive payload component into an active load-bearing element. During high-thrust maneuvers—such as rapid acceleration, sudden yaw correction, or aggressive banking—the drone's central body experiences significant lateral deformation forces. The reinforced guiding rail assembly resists this deformation by distributing loads between the bonded carbon fiber plates and the battery casing, thereby increasing the torsional stiffness of the entire central body portion. As a result, the central frame resists twisting more effectively, which in turn maintains precise alignment of the hollow arms and propeller axes, ensuring stable aerodynamic performance.

The technical effect of this embodiment is twofold. First, it guarantees secure retention of the battery, preventing vibration-induced shifting or inertial ejection under high dynamic loads. Second, and more importantly, it converts the battery bay into a structural reinforcement feature, enhancing the stiffness-to-weight ratio of the drone frame without adding additional reinforcing elements. This dual functionality optimizes weight efficiency while simultaneously increasing the durability and responsiveness of the frame under flight stresses.

The technical advancement over conventional designs lies in this integration of the battery and guiding rail system into the structural mechanics of the frame. Typically, drones house batteries in simple cavities or strap them externally, treating the battery only as a power source. Such configurations do not contribute to the mechanical rigidity of the airframe and often require additional structural ribs or cross-members to resist deformation. By contrast, the present embodiment leverages the rigid casing of the battery as part of the airframe itself, achieving reinforcement without additional material penalties. This results in a lighter yet stiffer central frame, a significant advantage in aerial vehicles where every gram of saved mass translates directly to increased endurance and payload capacity.

For example, during a high-thrust climb maneuver carrying an auxiliary imaging payload, lateral stresses attempt to twist the central frame. In a conventional drone, this may cause slight arm misalignments, leading to oscillations or drift in flight stability. In this embodiment, the engaged battery and guiding rails act as a torsional brace, preventing distortion of the frame and keeping the propeller disc planes precisely aligned. The drone therefore exhibits smoother flight characteristics, reduced control effort, and improved efficiency, extending both the mission duration and operational reliability.

In an embodiment, the floats (112) are symmetrically distributed about both the longitudinal and lateral axes of the carbon fiber frame (102), and wherein the buoyancy forces generated by the floats (112) cooperate with the lateral confinement of the protective cage (110) such that, when the drone system (100) tips laterally during flotation, the submerged floats (112) provides a restoring buoyant force while the protective cage (110) provides a counter-balancing contact point against the water surface, thereby generating a self-righting torque without requiring actuation of the motors (106).

In this embodiment, the floats (112) are carefully distributed symmetrically about both the longitudinal axis and the lateral axis of the carbon fiber frame (102), ensuring balanced buoyancy in all orientations. This four-way symmetry allows the drone system (100) to maintain hydrostatic equilibrium regardless of directional tilt. The buoyant forces generated by the floats act not only to displace water but also to counteract tipping disturbances by creating restoring torques. When the drone tips laterally—for example, due to a side wave or uneven water currents—the float on the submerged side increases its displaced volume, thereby generating a greater buoyant force than the float on the elevated side. This difference in buoyancy forms a restoring moment that pushes the drone back toward its upright position.

The protective cage (110) cooperates with this flotation arrangement to provide additional self-righting stability. As the drone tilts, the cage, which extends outward around the propellers (104), makes surface contact with the water on the elevated side. This contact functions as a counter-balancing point, resisting further roll and assisting the submerged float in generating corrective torque. Importantly, this interaction between the floats and the cage creates a self-righting torque pathway that is purely passive, relying only on buoyant and contact forces rather than requiring active stabilization from the motors (106).

The technical effect is that the drone system can recover from lateral displacements on water without expending energy or relying on flight control inputs. This passive self-righting mechanism enhances endurance and safety, as the motors do not need to spin up merely to maintain upright flotation, preserving battery power for mission-critical operations. Furthermore, because the self-righting occurs automatically through the geometry of the floats and cage, the drone maintains stability even if momentarily powered down or if sensor input is compromised. The technical advancement of this embodiment lies in the cooperative coupling of flotation geometry and protective structure. Conventional water-landing drones rely solely on pontoons or floats arranged along a single axis, which provide buoyancy but often fail to resist lateral capsizing forces, especially in choppy conditions. Others attempt to counteract tipping with active motor control, which consumes energy and may fail if the motors are momentarily disabled. By contrast, the present embodiment integrates the cage and float placement such that buoyant asymmetry and structural contact forces naturally generate restoring torque, achieving reliable self-righting without external control systems.

A practical example highlights the advantage: during a river monitoring mission, the drone may be disturbed by lateral currents, tipping 300 off vertical. In this state, the submerged float generates increased buoyancy while the cage on the opposite side touches the water surface, creating a balanced corrective moment. Within seconds, the drone rights itself to an upright floating orientation without motor intervention. This ensures operational continuity, prevents propeller submersion, and extends mission duration, especially in scenarios where power must be conserved.

Thus, the embodiment demonstrates technical efficacy by combining symmetric buoyancy distribution with cage-assisted surface interaction, delivering a passive, energy-free self-righting capability that significantly enhances the robustness and dual-environment versatility of the drone system (100).

In an embodiment, the protective cage (110) is configured as a sacrificial bumper assembly such that, upon repeated collision events, the arcuate struts deform elastically against the elastomeric bushings seated in the sockets of the hollow arms and progressively dissipate energy, and wherein the retention pins can be withdrawn to replace the protective cage (110) independently of the motors (106) and the floats (112), thereby enabling maintenance of the drone system (100) by modular replacement of the cage without disturbing the flotation or propulsion subsystems.

In this embodiment, the protective cage (110) is intentionally engineered as a sacrificial bumper assembly, designed to absorb and dissipate collision forces without transmitting destructive loads into the carbon fiber frame (102). The cage is constructed from arcuate struts arranged in a geodesic pattern, and when an impact occurs—such as striking a wall, tree branch, or structure—the struts deform elastically against the elastomeric bushings that seat them within the sockets of the hollow arms. This elastic deformation serves two critical functions: first, it absorbs a portion of the kinetic energy, preventing brittle fracture or crack propagation in the carbon fiber frame; second, it allows the energy to be progressively dissipated across multiple struts and bushings, rather than being concentrated at a single failure point.

Over time, after multiple collision events, the protective cage may experience plastic deformation, fatigue, or surface wear. Instead of requiring disassembly of the drone's propulsion system (motors (106)) or flotation system (floats (112)), this embodiment incorporates removable retention pins that mechanically secure the cage nodes within the sockets. By simply withdrawing these pins, the entire cage can be detached and replaced as a single modular unit. This modular replacement capability drastically reduces maintenance time and cost, allowing operators to restore the drone to operational readiness in the field without specialized tools.

The technical effect of this embodiment is the creation of a low-maintenance, impact-resilient drone architecture. The cage functions like a vehicle bumper: it deforms and sacrifices itself to protect higher-value structural and functional components. By isolating the protective function into a replaceable subsystem, the drone can withstand repeated impacts without structural compromise, and when the cage is finally worn out, it can be swapped independently of critical assemblies. This also ensures that the motors, wiring, and floats remain undisturbed during maintenance, preserving electrical connections and buoyancy integrity.

The technical advancement over conventional drones lies in combining sacrificial energy absorption with true modularity. Typical drones employ fixed propeller guards or rigid cages that either fail catastrophically under repeated collisions or require disassembly of multiple systems for replacement. Others use lightweight clip-on guards that are not integrated into the structural energy-dissipation pathway, meaning impacts are transmitted directly to the arms. The present embodiment advances beyond these limitations by embedding the cage into a compliant, elastomer-buffered joint system that both protects and isolates the frame, while also providing for tool-free modular replacement. This embodiment therefore demonstrates technical efficacy by ensuring that the drone system (100) is both impact-tolerant and field-serviceable, representing a major improvement in durability, maintainability, and mission reliability for dual-environment drones.

In an embodiment, the carbon fiber frame (102) includes the hollow arms that are integrally bonded to the central body portion such that impact forces absorbed by the protective cage (110) at the distal arm sockets are transmitted through the hollow arms into the central body portion, and wherein the floats (112) positioned beneath the central body portion absorb corresponding reaction loads during flotation, thereby forming a continuous load path from the protective cage (110) through the arms and into the floats (112) for combined aerial and aquatic stability.

In this embodiment, the carbon fiber frame (102) is designed so that the hollow arms are integrally bonded to the central body portion, creating a unified monocoque-like structure that efficiently distributes loads. When the protective cage (110) absorbs an impact at the distal arm sockets—for example, during a collision with a wall or tree—the resulting force is not localized at the socket interface but instead transmitted longitudinally through the hollow arms into the central body portion. Because the arms are integrally bonded rather than mechanically fastened, the load transfer occurs smoothly across the fiber layers of the composite, eliminating stress concentrations at fastener points and greatly increasing structural resilience.

During aquatic operation, a complementary load path is established through the floats (112). Positioned directly beneath the central body portion, the floats provide reaction loads against buoyant forces. When the drone lands on water, the protective cage may experience lateral contact forces from floating debris or waves, and these loads, once transmitted through the arms into the central body portion, are then counterbalanced by the upward buoyant reaction of the floats. The result is a continuous load path: impact energy enters at the cage nodes, travels through the arms, disperses into the central body, and is then stabilized by the flotation system. This integrated structural pathway allows the drone to maintain both aerial stability (resisting torsional deflections during flight) and aquatic stability (absorbing and balancing forces while floating) in a single unified design.

The technical effect is that the drone achieves a high level of mechanical efficiency and dual-environment robustness. By treating the arms, body, cage, and floats as an interconnected structural system, the design avoids isolated weak points and ensures that both impact forces and buoyancy reactions are absorbed in a coordinated manner. In aerial mode, this results in more rigid arm alignment and thus improved propeller stability. In aquatic mode, the structural connection between the cage, arms, and floats means that disturbances caused by water contact are dampened and balanced across the entire frame, reducing the risk of capsizing or localized failure.

The technical advancement over conventional drone designs lies in the creation of a continuous structural load-sharing architecture. In most drones, propeller guards are bolted or clipped to the arms, and floats are strapped or mounted separately, meaning impacts or buoyancy forces act in isolation, often leading to detachment or localized cracking. By contrast, this embodiment integrates the cage, arms, body, and floats into a unified load-bearing system, providing combined aerial-aquatic stability while minimizing part count and assembly complexity.

For example, during a maritime surveillance mission, the drone may collide with a buoy while floating. The cage absorbs the initial impact, the hollow arms distribute the force into the central frame, and the floats simultaneously provide upward buoyancy, preventing rollover or sinking. Similarly, during aerial operations in strong wind gusts, thrust imbalances that normally twist arms are resisted more effectively due to the increased torsional stiffness of the continuous load path. Thus, the embodiment demonstrates technical efficacy in ensuring that the drone remains stable, resilient, and mission-ready across both air and water environments, representing a significant advancement in hybrid drone design.

In an embodiment, the elastomeric suspension posts supporting the flight controller (114) are positioned such that their axes are inclined relative to the vertical axis of the central body portion, and wherein the inclined orientation causes vibrational loads transmitted through the carbon fiber frame (102) to be resolved into both shear and compression within the elastomer, thereby increasing the damping efficiency of the suspension posts across multiple vibration modes induced by the motors (106).

In this embodiment, the elastomeric suspension posts used to support the flight controller (114) are not mounted strictly along the vertical axis of the central body portion of the carbon fiber frame (102), but instead are deliberately positioned with their axes inclined relative to vertical. This geometrical orientation is crucial because it changes how the suspension system interacts with vibrational loads transmitted through the carbon fiber frame during drone operation.

When the motors (106) and propellers (104) generate thrust, they also produce vibrations of varying frequencies and amplitudes. These vibrations propagate into the carbon fiber frame, where they can couple into the flight controller, potentially distorting readings from the onboard inertial sensors. In a conventional suspension where the elastomeric posts are aligned vertically, most vibrational energy is absorbed as simple compression-relaxation cycles, which are less efficient at attenuating complex vibration modes such as torsional or lateral oscillations. By inclining the suspension posts, the vibrational forces are no longer aligned purely along the compression axis of the elastomer. Instead, each vibratory input is decomposed into components that act both in compression and in shear within the elastomeric material.

This dual-mode loading-shear plus compression-significantly increases the damping efficiency of the elastomer. Shear deformation, in particular, is more effective for dissipating vibrational energy as internal heat in elastomeric materials, while compression provides the preload stability necessary to prevent looseness or resonance. Together, the inclined posts broaden the damping spectrum, allowing the suspension system to attenuate vibrations across multiple modes: axial oscillations, lateral shocks, torsional pulses, and even compound vibrations caused by propeller imbalance or sudden thrust transitions.

The technical effect of this embodiment is a measurable improvement in the vibration isolation of the flight controller, resulting in cleaner sensor data and more stable flight performance. Because vibrations are dissipated more efficiently before they reach the sensitive gyroscopes and accelerometers, the flight controller can operate without over-reliance on digital filtering, which often introduces latency. The drone therefore responds more accurately to control inputs, maintains smoother hovering even in gusty conditions, and executes precise maneuvers without oscillation.

The technical advancement lies in the specific use of inclined elastomeric suspension geometry to achieve multi-mode damping. Conventional drones often use vertical soft mounts or flat pads, which only partially suppress vibrations and are optimized for a narrow frequency range. Such systems may fail to adequately damp torsional modes or high-frequency oscillations, leading to resonance amplification. By reorienting the suspension posts, this embodiment creates a hybrid damping pathway that suppresses both low-frequency thrust-induced oscillations and high-frequency motor harmonics, without requiring additional weight or complex active stabilization.

For example, during a precision mapping mission, the drone may fly at low altitude in turbulent air where rapid motor RPM adjustments occur. These thrust fluctuations induce a combination of vertical and lateral frame vibrations. In a standard vertically mounted suspension system, lateral components could transmit directly into the flight controller, corrupting accelerometer data and producing jitter in the flight path. In this embodiment, however, the inclined elastomeric posts resolve those lateral components into shear deformation, dissipating their energy before they reach the controller. The result is stable sensor output, smoother flight lines, and improved mapping accuracy.

In an embodiment, the arcuate struts of the protective cage (110) are arranged such that the intersections at the geodesic junctions form closed triangular bracing patterns, and wherein each triangular bracing pattern spans across adjacent propeller discs, thereby distributing localized collision loads on one side of the cage (110) into both adjacent arms of the carbon fiber frame (102), thereby preventing localized collapse of the cage (110) during oblique impacts.

In this embodiment, the arcuate struts of the protective cage (110) are carefully arranged so that their intersections at the geodesic junctions form a series of closed triangular bracing patterns. This geometry is not arbitrary; it is specifically chosen because triangular arrangements are inherently stable structural units that resist deformation under load. By creating such triangular bracing patterns across the surface of the cage, the structure gains the ability to maintain its shape and distribute forces efficiently, even when subjected to unexpected or oblique impact loads.

A particularly advantageous feature of this configuration is that each triangular bracing pattern is oriented such that it spans across two adjacent propeller discs. In conventional designs, a collision that strikes one side of the protective cage near a single propeller is absorbed primarily by that local segment of the cage, concentrating stress in a small area and risking collapse or detachment of that segment. In contrast, with this embodiment, an oblique impact on one side of the cage engages not just the local struts but also transfers load through the triangular bracing to the neighboring geodesic junctions. From there, the load is redirected into both adjacent arms of the carbon fiber frame (102) rather than being confined to a single arm.

This distributed load path yields several critical technical effects. First, it prevents localized failure by ensuring that no single arm or strut carries the full brunt of an impact. Second, it transforms the cage into a structural energy-dissipation network, where impact forces are spread and dissipated throughout the geodesic lattice. Third, by engaging multiple arms during impact, the drone maintains better geometric integrity of the cage, keeping the propellers (104) continuously shielded. For example, if the drone collides obliquely with a vertical post, instead of denting inward at one propeller and collapsing that side of the cage, the triangular bracing spreads the load across adjacent arms, preserving the spherical enclosure and preventing the propeller from making direct contact with the obstacle.

The technical advancement of this embodiment lies in the deliberate use of triangular geodesic bracing patterns across propeller spans. Conventional cages often rely on ring or crossbar geometries, which provide protection but lack redundancy: once one segment fails, the entire cage loses structural integrity. Here, the triangular bracing ensures redundancy and multi-arm load sharing, a design principle taken from geodesic dome engineering and applied innovatively to drone protective structures. This is particularly critical for drones intended for operations in cluttered environments such as forests, warehouses, or ship decks, where oblique glancing impacts are more common than direct frontal collisions.

A practical example illustrates the effect: during an indoor inspection mission, the drone collides diagonally with a steel beam. The bracing patterns spanning adjacent propellers redirect the impact force into both the left and right arms simultaneously, dissipating energy and preventing collapse of the impacted side of the cage. The drone continues operating without propeller damage, avoiding downtime and mission failure.

Thus, this embodiment demonstrates technical efficacy by ensuring that the protective cage (110) resists localized collapse during oblique impacts, maintains continuous shielding of propellers, and extends the operational survivability of the drone system (100).

In an embodiment, each floats (112) extends below the lower surface of the carbon fiber frame (102) and is configured with a flat lower bearing surface, the flat surface being parallel to the lower plate of the central body portion, such that the floats (112) act as stabilizing skids during take-off and landing on ground surfaces, and wherein the keyed dovetail recess and locking pin ensure that ground impact loads are transmitted directly into the carbon fiber frame (102) without causing detachment of the floats (112).

In this embodiment, the floats (112) are designed not only as buoyant elements for aquatic operation but also as dual-purpose structural members that serve as stabilizing skids during terrestrial take-off and landing. Each float extends below the lower surface of the carbon fiber frame (102) and is finished with a flat lower bearing surface. This surface is manufactured parallel to the lower plate of the central body portion, ensuring that when the drone system (100) lands on a planar ground surface, all floats engage simultaneously and evenly. This flat-surface contact prevents rocking, tipping, or localized stress concentrations that could otherwise occur with rounded pontoons or narrow skids. The floats therefore provide a stable platform for launch and landing, reducing the risk of propeller strikes against uneven ground or debris.

The structural integration is further strengthened by the use of a keyed dovetail recess and locking pin mechanism. The rigid insert within each float is seated into a complementary dovetail recess machined into the frame. Because of the dovetail's interlocking geometry, vertical pull-out and rotational twisting of the float are mechanically prevented. The locking pin, which passes transversely through both the rigid insert and the recess wall, adds a redundant securing pathway. This means that during ground landings, where vertical impact loads are significant, the forces are not absorbed by the foam or buoyant material of the float but are instead transmitted directly into the carbon fiber frame through the rigid insert. The frame, being the primary load-bearing structure, dissipates these loads effectively without risk of float detachment or damage.

The technical effect of this embodiment is the creation of a hybrid float-skid system that allows the drone to operate equally well on land and water without requiring separate landing gear. On land, the floats act as rigid skids, stabilizing the drone during take-off and landing cycles while keeping the propellers (104) elevated above the ground. On water, they continue to serve their primary buoyancy function, maintaining flotation stability. The keyed dovetail and locking pin ensure that in both modes, structural loads are efficiently transmitted into the frame, safeguarding the integrity of the float assemblies.

The technical advancement over conventional designs lies in this integrated dual-role functionality. Traditional drones often employ independent skid landing gear for ground operations and external pontoons for aquatic use, resulting in additional weight, complexity, and failure points. In contrast, this embodiment consolidates these functions into a single set of floats engineered to handle both impact loading on ground surfaces and hydrostatic loading in aquatic environments. This reduces part count, improves reliability, and enhances mission versatility.

As an example, during a mixed-environment reconnaissance mission, the drone may launch from a concrete pier, land on open water to collect data, and then return to ground landing. Upon ground contact, the flat-bearing surfaces of the floats provide stability, while the dovetail-recessed inserts ensure that the energy from impact is absorbed into the frame, not the floats. Upon water landing, the same floats provide buoyant support, keeping the drone upright and stable. This seamless dual-functionality demonstrates the technical efficacy of the design, ensuring robust performance across operational environments while reducing maintenance and part replacement requirements.

In an embodiment, each electronic speed controller (108) is secured to an inner surface of the lower plate of the carbon fiber frame (102) in alignment with a corresponding hollow arm, the electronic speed controller (108) being mechanically fastened with a vibration-isolating mount and thermally coupled to the lower plate to dissipate heat, and wherein motor phase wires extend directly from the electronic speed controller (108) through the internal conduit of the hollow arm to the motor (106), thereby minimizing wire exposure and protecting electrical connections from mechanical strain.

In this embodiment, each electronic speed controller (ESC) (108) is structurally and thermally integrated into the carbon fiber frame (102) to optimize both reliability and efficiency of the propulsion subsystem. Each ESC is mounted on the inner surface of the lower plate of the central body portion, directly in alignment with its corresponding hollow arm. This alignment provides the shortest possible electrical pathway between the ESC and the motor (106), significantly reducing wire length, minimizing resistive losses, and improving overall electrical efficiency.

The ESCs are mechanically fastened using vibration-isolating mounts, such as elastomeric grommets or pads, which prevent high-frequency oscillations generated by the motors and propellers from coupling into the ESC circuitry. This isolation reduces the likelihood of solder joint fatigue, component microcracking, or premature electronic failure caused by continuous vibrational stress. At the same time, the ESCs are thermally coupled to the lower plate of the carbon fiber frame. The carbon fiber plate, often manufactured with thermally conductive epoxy resins or integrated heat spreader layers, functions as a passive heatsink. Heat generated by the ESC's power transistors during operation is conducted away into the lower plate, where it dissipates into the surrounding airflow. This passive cooling arrangement is particularly effective during flight, as the plate is exposed to downward airflow generated by the propellers, further enhancing convective heat removal.

The motor phase wires extend directly from each ESC into the internal conduit of the corresponding hollow arm, eliminating the need for external wiring. This routing not only protects the wires from abrasion, snagging, or environmental exposure but also places them within the neutral axis of the arm, ensuring that they are shielded from bending-induced stress during torsional loading of the arms. By avoiding external cable runs, aerodynamic drag is also reduced, and the overall system achieves a cleaner, more streamlined profile.

The technical effect of this embodiment is a propulsion subsystem that is simultaneously electrically efficient, mechanically protected, and thermally stabilized. By shortening wire paths and embedding them within the structure, resistive losses and mechanical strain are minimized. By thermally coupling ESCs to the lower plate, continuous operation at higher thrust levels becomes possible without overheating. By isolating ESCs from vibration, electronic reliability and service life are extended.

The technical advancement lies in the multi-functional integration of ESCs into the structural frame. Conventional drones typically mount ESCs externally on arms, where they are fully exposed to airflow but vulnerable to mechanical impact, or inside the central body, where they are shielded but prone to overheating. This embodiment balances both by combining thermal coupling with vibration isolation, while keeping ESCs aligned to arms for efficient wiring. It represents a structural-electrical co-design approach that enhances overall system robustness and efficiency without additional mass penalties.

A practical example illustrates the efficacy: during a high-endurance aerial survey mission, the drone operates for extended periods at near-maximum thrust. In conventional drones, ESCs mounted externally may overheat or suffer from wire fatigue due to vibration and environmental exposure. In this embodiment, heat from the ESCs is efficiently drawn into the carbon fiber lower plate and carried away by propeller-driven airflow, keeping operating temperatures within safe limits. The motor phase wires, being routed internally, remain secure even under repeated arm flexing during gusty flight conditions. This ensures continuous and reliable propulsion, enhancing flight stability, mission duration, and system longevity.

In an embodiment, the central body portion of the carbon fiber frame (102) further supports an imaging assembly comprising a thermal camera (120), a pilot camera (122), and an RGB camera (124), the thermal camera (120) and RGB camera (124) being mounted on a gimbal assembly secured to the underside of the lower plate, and the pilot camera (122) being fixed to a forward-facing bracket of the frame (102), wherein the floats (112) extend below the gimbal assembly to maintain clearance between the imaging assembly and a ground or water surface during landing, and the protective cage (110) extends forward of the pilot camera (122) to provide collision shielding without obstructing its field of view; and The drone system (100) of claim 1, wherein the central body portion of the carbon fiber frame (102) further houses a flight computer (116) including a processor (116a), the flight computer (116) being mechanically mounted on a heat-dissipating carrier plate secured to the lower plate of the carbon fiber frame (102), and wherein a LiDAR sensor (118) is fixed to an upper mounting bracket of the carbon fiber frame (102) in an elevated position relative to the propellers (104), the LiDAR sensor (118) being mechanically isolated from vibration of the carbon fiber frame (102) by an elastomeric pad, such that the flight computer (116) and the LiDAR sensor (118) are structurally integrated with the drone system (100) while remaining mechanically stabilized during aerial and aquatic operation.

In this embodiment, the central body portion of the carbon fiber frame (102) is further engineered as a multi-sensor integration hub, supporting both imaging and computational subsystems while ensuring mechanical stability across aerial and aquatic environments.

The imaging assembly includes a thermal camera (120) and an RGB camera (124) mounted on a precision gimbal assembly secured to the underside of the lower plate of the frame. This gimbal provides active stabilization, enabling the cameras to capture blur-free imagery even when the drone is in turbulent flight or exposed to wave-induced motion during flotation. A pilot camera (122) is mounted separately on a forward-facing bracket of the frame to provide the operator with a real-time flight perspective independent of the gimbal-mounted sensors. Importantly, the floats (112) extend below the gimbal assembly, ensuring that during both ground and aquatic landings, the imaging payload remains elevated and clear of contact with surfaces. This arrangement prevents damage to sensitive optics and gimbal motors, even when operating in rugged terrain or rough water conditions. Simultaneously, the protective cage (110) extends forward of the pilot camera (122), acting as a collision shield against obstacles such as branches, walls, or debris. The cage geometry is optimized so that it does not obstruct the camera's field of view, enabling uninterrupted video streaming for navigation.

Within the same central body portion, a flight computer (116) housing a processor (116a) is mounted on a heat-dissipating carrier plate attached to the lower plate of the carbon fiber frame. This thermal pathway ensures that computational loads generated during real-time video processing, sensor fusion, or autonomous navigation do not overheat the processor. The carbon fiber plate acts as a passive heatsink, dissipating heat into airflow beneath the drone. By coupling the processor to a structural member, this embodiment eliminates the need for bulky standalone cooling systems, thereby improving weight efficiency.

Additionally, a LiDAR sensor (118) is mounted on an upper bracket of the carbon fiber frame, positioned above the propeller plane to ensure an unobstructed scanning field. Because LiDAR accuracy depends on vibration-free operation, the sensor is seated on an elastomeric pad that mechanically isolates it from frame oscillations. This damping mechanism prevents high-frequency motor-induced vibrations from corrupting LiDAR data, thereby ensuring reliable 3D mapping and obstacle detection in real time.

The technical effect of this embodiment is the creation of a drone that combines advanced multi-modal sensing with robust mechanical integration. The imaging assembly provides thermal, RGB, and pilot views without risk of ground or water interference. The flight computer, stabilized and thermally managed, enables on-board high-speed computation for real-time decision-making. The LiDAR sensor, vibration-isolated, provides precise spatial awareness. Together, these components allow the drone to operate as a reconnaissance, inspection, or mapping platform in environments where both aerial and aquatic stability are essential.

The technical advancement lies in the co-optimization of sensor placement, mechanical stability, and thermal management within the carbon fiber frame itself. Conventional drones typically require external gimbals, mounts, or housings to accommodate such sensors, often increasing bulk and introducing points of weakness. Here, the floats, cage, and frame geometry are arranged to inherently protect and stabilize sensors without sacrificing field of view or thermal performance. The result is a lighter, more compact, and more durable drone system capable of dual-environment operations with advanced sensing capability.

A practical example underscores the efficacy: in a search-and-rescue scenario, the drone hovers over floodwaters. The thermal camera detects heat signatures of survivors, the RGB camera captures high-resolution visuals, and the pilot camera ensures precise operator control. When the drone descends to land briefly on water, the floats keep the gimbal assembly above the surface, preventing sensor wetting. Meanwhile, the LiDAR continues to generate terrain profiles even in low-light or visually degraded conditions, and the processor analyzes and streams this data in real time. The protective cage shields the forward pilot camera from floating debris while maintaining a clear visual feed. In this way, the embodiment demonstrates technical efficacy by integrating multiple sensing and computational subsystems into a mechanically stable, dual-environment drone platform that advances beyond conventional aerial-only UAV systems.

In an embodiment, the power system (126) comprises a battery (126a) retained in a bay defined by parallel guiding rails of the carbon fiber frame (102), a power module (126b) mechanically mounted adjacent to the battery bay on the lower plate, and a universal battery elimination circuit (126c) fixed to a circuit board carrier within the central body portion, wherein the guiding rails, the power module (126b), and the universal battery elimination circuit (126c) are structurally integrated with the carbon fiber frame (102) such that inertial forces acting during abrupt acceleration or aquatic impact are distributed across the frame, thereby preventing localized deformation of the central body portion and maintaining stable electrical connectivity to the flight controller (114) and associated components.

In this embodiment, the power system (126) of the drone system (100) is configured not as a loosely mounted set of electronic modules, but as a structurally integrated subsystem built directly into the carbon fiber frame (102). The system includes three primary elements: a battery (126a), a power module (126b), and a universal battery elimination circuit (UBEC) (126c).

The battery (126a) is retained in a bay defined by parallel guiding rails within the central body portion of the frame. These guiding rails secure the battery laterally and vertically, ensuring that under high inertial loads, such as abrupt acceleration or rapid deceleration, the battery casing remains locked in place without shifting. The rigid mechanical engagement prevents intermittent electrical disconnection and at the same time converts the battery from a simple payload element into a structural contributor within the frame.

Adjacent to the battery bay, a power module (126b) is mechanically mounted on the lower plate of the carbon fiber frame. This mounting not only ensures direct coupling for efficient thermal dissipation but also positions the power module in alignment with the load-bearing geometry of the frame. Meanwhile, the universal battery elimination circuit (126c)—a key power-conditioning component that provides stable voltage to sensitive electronics such as the flight controller (114)—is securely fixed to a circuit board carrier within the central body. The carrier itself is bonded to the frame, ensuring that the UBEC is isolated from vibration while still benefiting from structural reinforcement.

The critical design feature of this embodiment is that the guiding rails, the power module, and the UBEC are all structurally integrated into the frame, meaning inertial forces during operation are not borne by any single module but are instead distributed evenly into the carbon fiber structure. For example, during a high-thrust ascent, the upward inertial load on the battery is absorbed by the guiding rails and transmitted into the frame rather than stressing the electrical connectors. Similarly, during an aquatic impact, such as when the drone lands heavily on water and experiences vertical shock loads, the reaction forces are dispersed across the lower plate, with the power module and UBEC remaining securely fastened without deformation or misalignment.

The technical effect of this embodiment is the assurance of continuous electrical connectivity and stability under dynamic conditions. Because all components of the power system are integrated with the frame, there are no weakly mounted subsystems that can detach, vibrate loose, or deform under stress. Electrical power flows consistently to the flight controller (114) and associated avionics, preventing mission-critical power interruptions. At the same time, the frame itself benefits from increased stiffness as these power modules function like embedded reinforcements.

The technical advancement lies in the structural-electrical co-design of the power system. Conventional drones often mount batteries with straps, power modules with screws onto plastic trays, and UBECs on separate circuit boards, all of which are vulnerable to inertial detachment, vibration damage, or localized deformation of lightweight housings. By embedding these components directly into the carbon fiber frame, the present embodiment achieves a rigid, vibration-resistant, and impact-tolerant power architecture that enhances overall system robustness and extends operational life.

A practical example illustrates the efficacy: during a rapid aerial maneuver followed immediately by a hard aquatic landing, inertial forces act simultaneously in multiple directions. In a conventional drone, the battery might shift in its housing, the power module might crack its mount, or the UBEC might experience intermittent connectivity-all leading to potential mid-mission power failure. In this embodiment, however, the battery rails lock the battery in place, the power module is absorbed into the frame's load path, and the UBEC remains rigidly supported, ensuring uninterrupted power supply. The drone therefore maintains stable propulsion, sensor operation, and communication links, even under extreme dual-environment conditions.

Thus, this embodiment demonstrates technical efficacy by ensuring that the power system is not a fragile appendage but an integrated structural subsystem of the drone, advancing the field toward more resilient, reliable, and mission-ready UAV architectures.

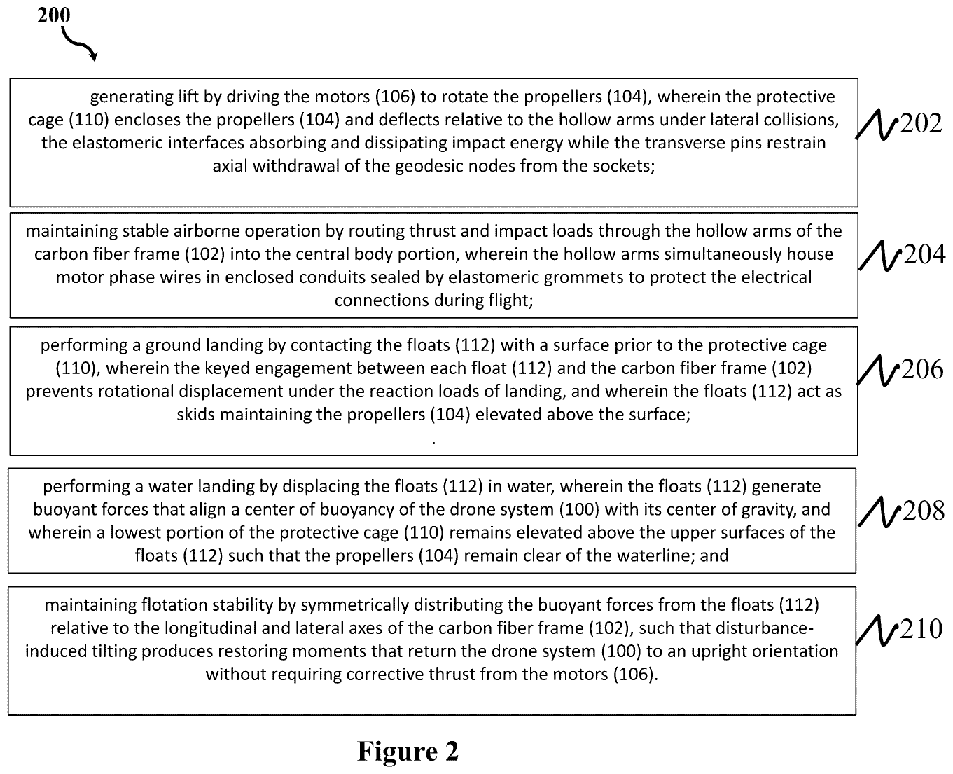

Referring to FIG. 2, a flow chart of a method of operating a drone system (100) comprising a carbon fiber frame (102) having a central body portion and radially extending hollow arms terminating in distal motor mount platforms, a plurality of motors (106) driving corresponding propellers (104), a protective cage (110) formed of arcuate struts joined at geodesic nodes and coupled to the hollow arms through elastomeric interfaces and transverse pins, and a plurality of floats (112) secured to a lower portion of the carbon fiber frame (102) by keyed recesses and locking members, the method comprising the steps is illustrated. The method 200 comprises: At step 202, the method 200 includes generating lift by driving the motors (106) to rotate the propellers (104), wherein the protective cage (110) encloses the propellers (104) and deflects relative to the hollow arms under lateral collisions, the elastomeric interfaces absorbing and dissipating impact energy while the transverse pins restrain axial withdrawal of the geodesic nodes from the sockets.

At step 204, the method 200 includes maintaining stable airborne operation by routing thrust and impact loads through the hollow arms of the carbon fiber frame (102) into the central body portion, wherein the hollow arms simultaneously house motor phase wires in enclosed conduits sealed by elastomeric grommets to protect the electrical connections during flight.

At step 206, the method 200 includes performing a ground landing by contacting the floats (112) with a surface prior to the protective cage (110), wherein the keyed engagement between each floats (112) and the carbon fiber frame (102) prevents rotational displacement under the reaction loads of landing, and wherein the floats (112) act as skids maintaining the propellers (104) elevated above the surface.

At step 208, the method 200 includes performing a water landing by displacing the floats (112) in water, wherein the floats (112) generate buoyant forces that align a center of buoyancy of the drone system (100) with its center of gravity, and wherein a lowest portion of the protective cage (110) remains elevated above the upper surfaces of the floats (112) such that the propellers (104) remain clear of the waterline.

At step 210, the method 200 includes maintaining flotation stability by symmetrically distributing the buoyant forces from the floats (112) relative to the longitudinal and lateral axes of the carbon fiber frame (102), such that disturbance-induced tilting produces restoring moments that return the drone system (100) to an upright orientation without requiring corrective thrust from the motors (106).

In this embodiment, a method of operating the drone system (100) is described, focusing on how the integrated structural, protective, and flotation features cooperate to enable safe, stable, and versatile performance in both aerial and aquatic environments.

The method begins by generating lift, wherein the motors (106) drive the propellers (104) to create upward thrust. During this phase, the protective cage (110), composed of arcuate struts joined at geodesic nodes, fully encloses the propellers, ensuring that accidental collisions with external objects—such as tree branches, cables, or structural beams—do not directly impact the rotating blades. When a lateral collision occurs, the cage does not fail rigidly but instead deflects relative to the hollow arms due to the presence of elastomeric bushings at the sockets. These bushings deform radially to absorb and dissipate impact energy, while the transverse pins restrain the geodesic nodes from withdrawing axially, maintaining the cage's positional integrity. This allows the drone to sustain contact events while remaining airborne, representing a significant advancement in collision survivability compared to drones without sacrificial or compliant protection.

Once airborne, the drone maintains stable flight operation by leveraging the hollow arms of the carbon fiber frame (102). These arms are structurally optimized to carry both torsional and bending loads induced by thrust, while also functioning as internal conduits for motor phase wires. The wires exit the conduits through sealed outlets fitted with elastomeric grommets, which provide strain relief and prevent moisture ingress. This dual-function design ensures that the arms simultaneously serve as structural beams and electrical protection channels, reducing external drag and improving aerodynamic efficiency.

For ground landings, the method emphasizes the role of the floats (112) as primary contact members. Because the floats extend below the frame, they contact the landing surface before the protective cage, thereby preventing propeller damage. The floats are secured to the frame using keyed dovetail recesses and locking pins, which prevent rotational displacement or detachment under ground impact loads. Functionally, the floats act as skids, providing broad, stable contact while keeping the propellers elevated above the surface, reducing dust ingestion and mechanical wear.

For aquatic landings, the floats act as buoyancy elements, displacing water and generating forces that naturally align the center of buoyancy with the center of gravity of the drone. This alignment ensures that the drone floats upright without requiring constant motor thrust for stabilization. Importantly, the lowest portion of the protective cage (110) is elevated above the float upper surfaces, meaning that even when floating, the propellers remain clear of the waterline. This eliminates the risk of propeller immersion, which could cause stalling, water ingestion, or destabilization.

Finally, the method maintains flotation stability through the symmetric distribution of the floats (112) relative to both the longitudinal and lateral axes of the frame. When the drone is tilted by external disturbances—such as wind gusts or water currents—the submerged float experiences greater displacement and buoyant force, while the elevated float generates reduced buoyancy. This asymmetry creates a restoring moment that pushes the drone back into upright equilibrium. Crucially, this self-righting stability is achieved without requiring corrective motor thrust, thereby conserving battery power and ensuring passive recovery even if propulsion is temporarily disabled.

The technical effect of this method is to enable seamless operation across both air and water environments, while preserving propeller safety, structural integrity, and flotation stability.

Each operational step leverages the unique mechanical integrations of the drone—compliant cage joints, hollow wire-conducting arms, keyed float engagement, and symmetric buoyancy distribution—to achieve performance outcomes not possible with conventional designs.

The technical advancement is in providing a drone that is not limited to a single environment, nor dependent on fragile, bolt-on pontoons or propeller guards. Instead, the drone incorporates integrated, multifunctional systems that allow it to fly, land on ground, land on water, and remain upright and stable—all with minimal energy expenditure and high reliability.

For example, in a disaster response mission, the drone can take off from a rough ground surface, perform aerial reconnaissance, land safely on floodwaters to capture thermal imagery of survivors, and maintain stable flotation while streaming live data. If struck by floating debris, the cage absorbs the impact, and if tipped by wave action, the buoyancy distribution restores upright orientation without pilot intervention. Thus, the method demonstrates technical efficacy by combining aerial versatility, aquatic survivability, and operational resilience in a single integrated workflow.

The present invention relates to an autonomous multifunctional inspection and rescue quadcopter drone system, wherein the drone system is configured to perform multifunctional operations, including industrial inspection, search and rescue, and environmental monitoring. The drone system integrates robust versatility by incorporating carbon fiber protective cages for safe indoor operations, integrated floats for water landing and floating capability, and advanced onboard sensors (LiDAR, thermal and RGB cameras) with AI-based processing through Jetson Orin Nano. This significantly reduces operational complexity and enhances capability in diverse environments. The drone system is configured with AI-driven navigation and fault detection capabilities, significantly enhancing efficiency and safety in inspection and rescue operations.

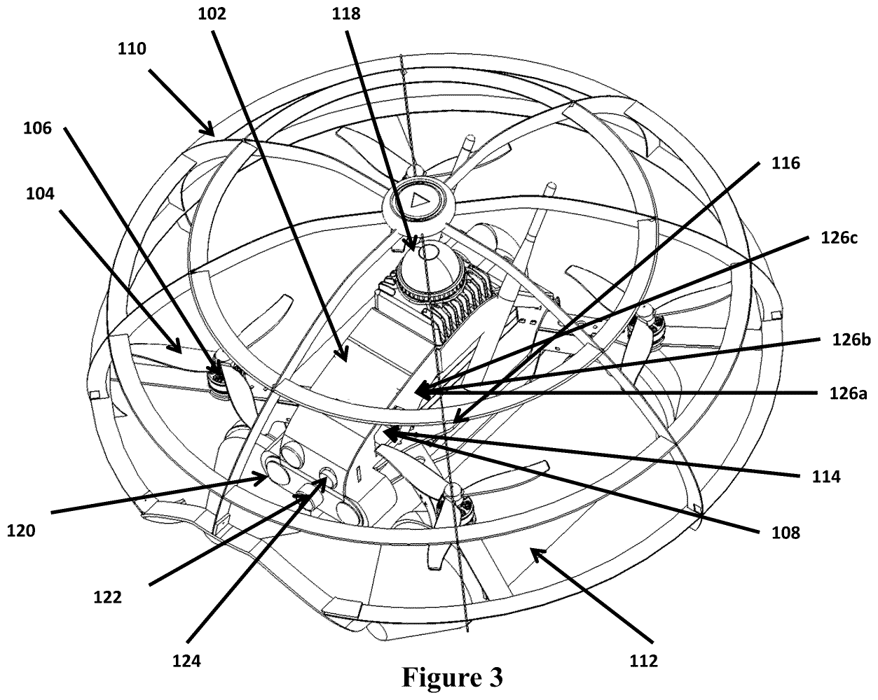

FIG. 3 illustrates a perspective view of the proposed drone system, in accordance with an embodiment of the present disclosure.

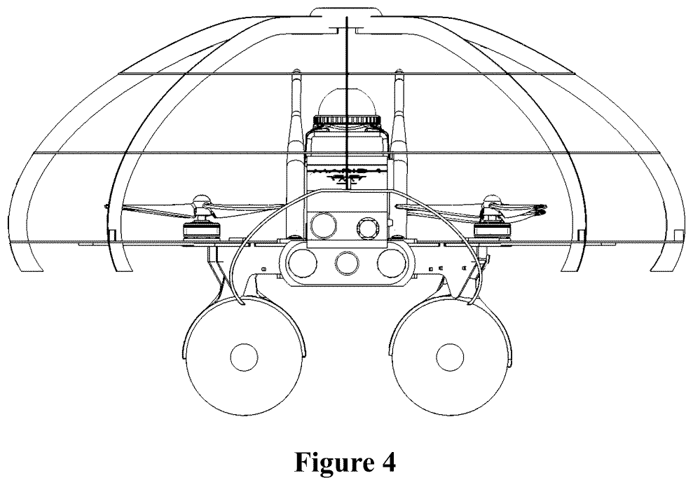

FIG. 4 illustrates a front view of the proposed drone system, in accordance with an embodiment of the present disclosure.

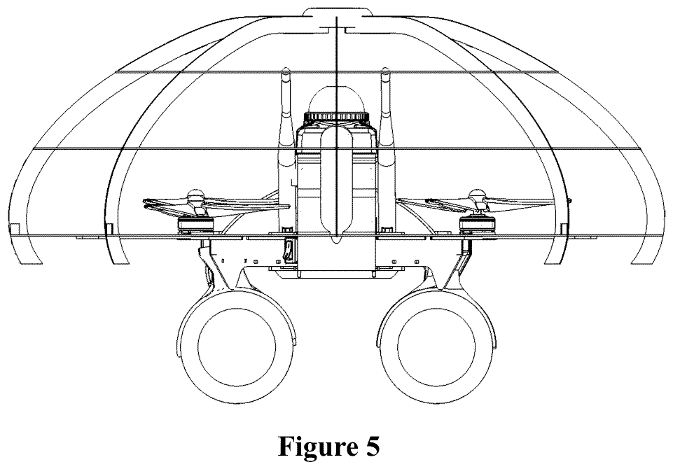

FIG. 5 illustrates the back view of the proposed drone system, in accordance with an embodiment of the present disclosure.

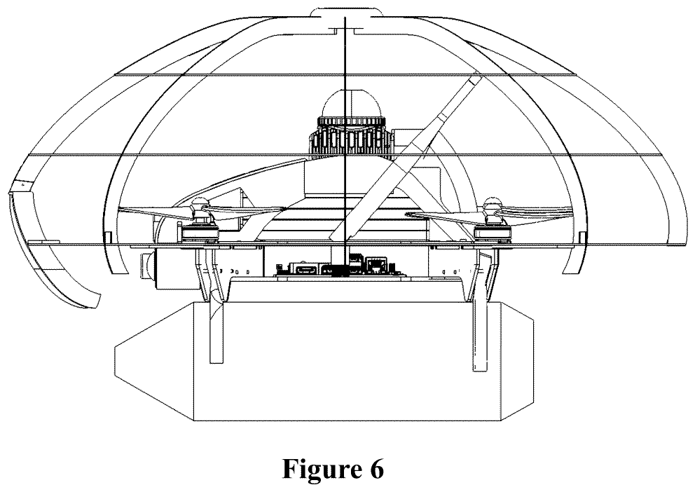

FIG. 6 illustrates the side view of the proposed drone system, in accordance with an embodiment of the present disclosure.

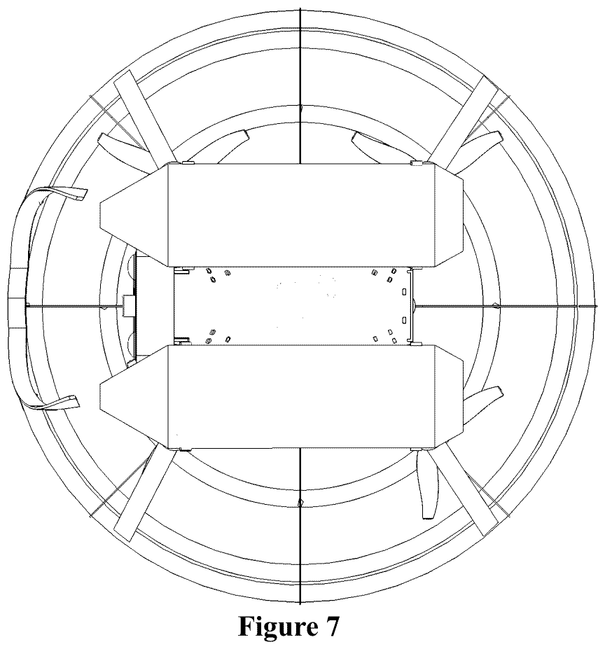

FIG. 7 illustrates the bottom view of the proposed drone system, in accordance with an embodiment of the present disclosure.

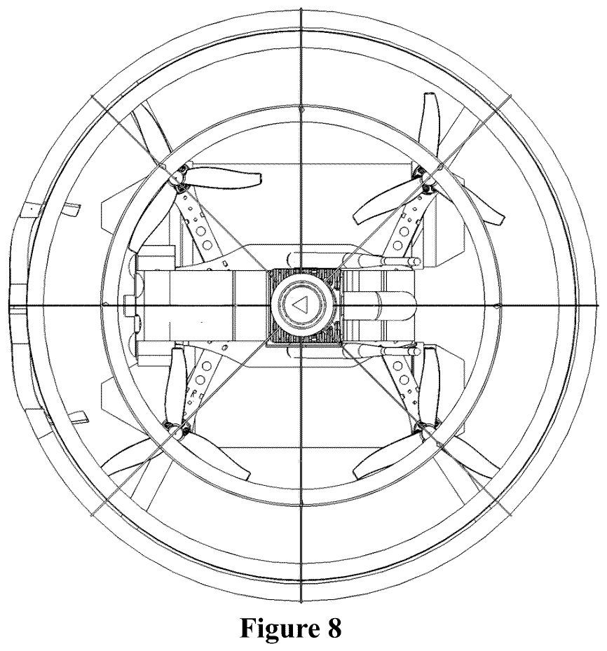

FIG. 8 illustrates the top view of the proposed drone system, in accordance with an embodiment of the present disclosure.

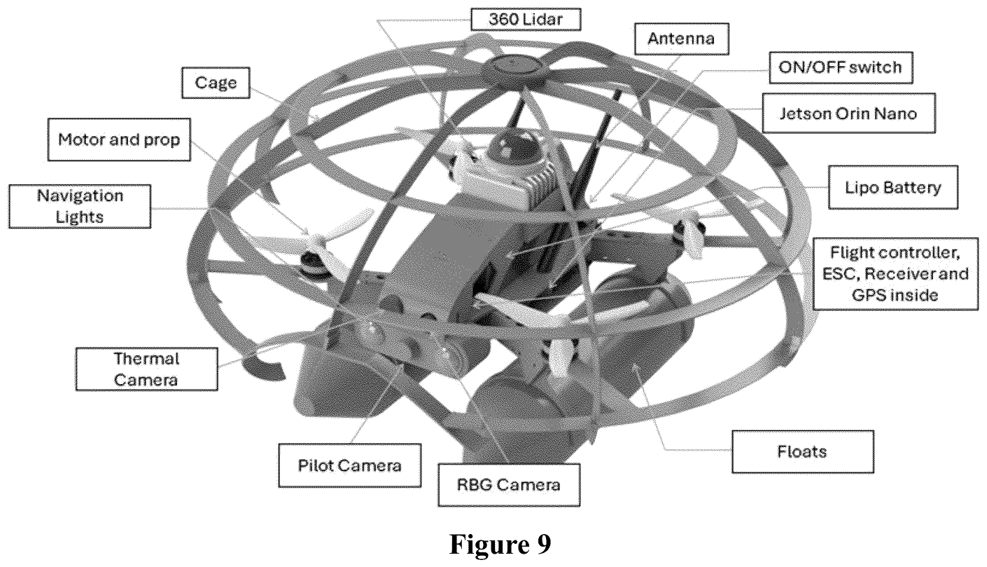

FIG. 9 illustrates the compressive overview of the proposed drone system, in accordance with an embodiment of the present disclosure.

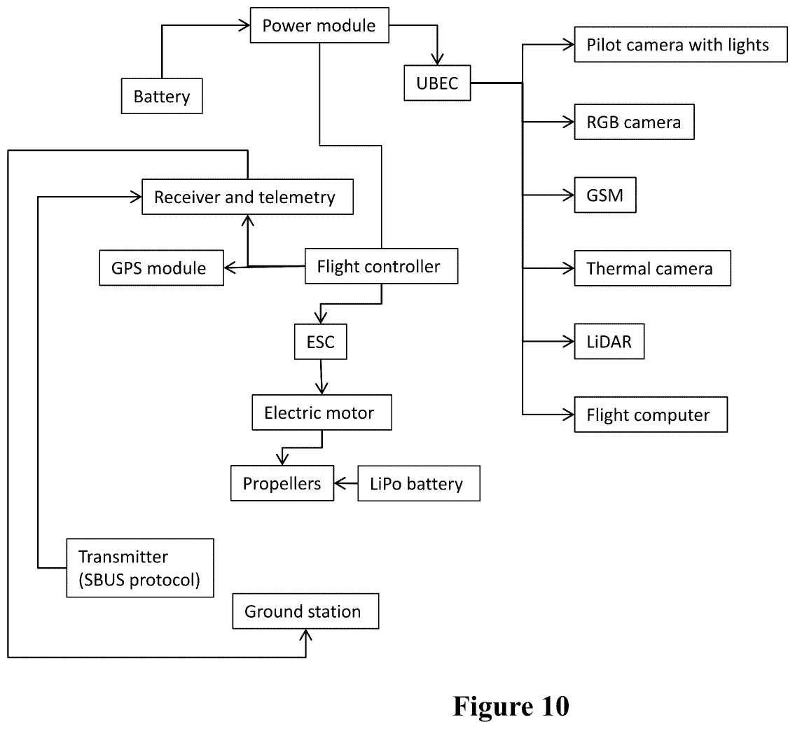

FIG. 10 illustrates the architectural overview of the proposed drone system, in accordance with an embodiment of the present disclosure.

The proposed advanced autonomous quadcopter drone system is designed for multifunctional inspection and rescue operations. The design of the system includes a lightweight, high-strength carbon fiber frame, as shown in FIG. 9, providing durability, resilience, and operational efficiency. The drone is structured in such a manner as to facilitate stable flights in diverse environments, including indoors, outdoors, and on water surfaces.

Referring to FIG. 9, the drone system comprises two specially designed lightweight floats that are attached symmetrically to the lower portion of carbon fiber frame, wherein said floats enable the drone to land on water, safely and stably, without submerging or tipping over. The system further incorporates a protective cage, also crafted from carbon fiber, fully encloses the drone's propellers and critical components, ensuring safety and operational stability, particularly during indoor navigation where collisions might occur.

Referring to FIG. 9, and FIG. 10, the drone system includes various electronic components, as described under:

The drone system includes a Flight Controller (Pixhawk 6C Mini), configured to manage essential flight dynamics, stabilization, autopilot features, GPS navigation, and communicates telemetry data to the ground station, enabling precise control and monitoring of drone operations.

The drone system further includes a flight Computer (Jetson Orin Nano) configured to serve as the onboard intelligence hub, responsible for executing advanced artificial intelligence algorithms. It processes real-time data collected from onboard sensors for autonomous obstacle avoidance, environmental mapping, and fault or anomaly detection.

The drone system further includes a pilot camera (Skydroid 3-body camera) configured to provide the pilot with a real-time visual feed crucial for manual control, navigation, and immediate environment assessment during complex inspection or rescue scenarios. The drone system further includes a plurality of advanced sensor for data collection, including a LiDAR sensor, a thermal sensor, and a RBS camera sensor. The LiDAR sensor (Livox Mid-360), is positioned strategically atop the drone, providing comprehensive 360-degree 3D mapping of surroundings, wherein the sensor actively scans the environment, delivering precise distance measurements to obstacles, thereby enabling sophisticated obstacle detection and avoidance capabilities essential for autonomous navigation. The thermal camera (UV256 9 mm USB) is integrated to enable thermal imaging, wherein the thermal camera effectively identifies thermal anomalies such as human or animal presence, potential gas leaks, or heat signatures indicative of mechanical or electrical faults during inspections. The RGB camera (Jetson Orin Nano compatible) is configured to capture high-resolution visual images for detailed inspection purposes, such as recognizing structural defects, pipeline conditions, or detecting objects. Images captured are processed onboard for real-time fault detection using AI algorithms.

The drone system further includes a power system comprising a 6S 5100 mAh Lithium Polymer (LiPo) battery, which is efficiently managed by a 90A PM02 power module, in order to provide electrical power for all components. The power system further comprises a UBEC (Universal Battery Elimination Circuit) that regulates power supply, ensuring stable voltage distribution to sensitive electronics such as the LiDAR, cameras, and flight computer.

The drone system further includes an electronic speed controller (ESC) and Motors, wherein the SpeedyBee 50A BLS 4-in-1 Electronic Speed Controller (ESC) manages motor power delivery, efficiently powering four T-Motor V2207 V3 1750 KV motors equipped with 5-inch propellers, ensuring responsive flight dynamics and sufficient thrust-to-weight ratio for agile maneuverability and stable hovering.

The drone system further include a telemetry and controlling unit with a Skydroid H12 telemetry receiver for real-time communication and telemetry, enabling continuous data transmission to the ground station for remote monitoring, manual override, or operational adjustments.

The proposed drone is capable of indoor, outdoor, and aquatic inspections, wherein the drone enables robust real-time thermal imaging and advanced 3D mapping. The protective cage of the drone ensures safety, and floats ensure water-floating capabilities. The drone system with artificial intelligence capabilities performs real-time autonomous navigation, fault detection, and obstacle avoidance.

The present invention provides a drone system for performing autonomous multifunctional inspection and rescue operations. The drone system can perform industrial inspection, search and rescue, and environmental monitoring.

In an implementation, the drone is active, powering up the onboard electronics, and performing an automatic pre-flight diagnostic to ensure the problem functional of all the systems, such as GPS, LiDAR, camera, propulsion, and sensors. The operator of the drone system configures the mission from the ground station, through the provided software. The drone is configured to autonomously follow the predefined flight path, as configured by the operator, or manually guided commands, wherein the flight controller and flight computer continuously share data and work together to adjust flight dynamics based on environmental conditions and sensor feedback. During the flight, the drone is configured to capture continuous real-time data through integrated sensors, such as LiDAR, thermal, and RGB camera, wherein this data is transferred to the flight computer of further processing to obtain actionable intelligence. The flight computer with Jetson Orion Nano processor is configured to execute advanced AI algorithms to analyze sensor data in real-time, automatically identifying obstacles, anomalies, structural issues, or thermal variations indicative of hazards or human presence. The drone utilizes LiDAR-generated 3D mapping and AI-driven image recognition, for performing autonomous detection of obstacles, allowing the drone to avoid the obstacles and adjust the flight path dynamically, which significantly reduces the risk of damage during inspectional operations. The data collected from the sensors are transmitted to the ground station, using a telemetry receiver, wherein the live telemetry and sensor data, including high-resolution images and thermal imaging results, are transmitted continuously to the ground station. This immediate data transfer supports real-time decision-making and rapid response during inspection or rescue operations.

In an embodiment, the drone system has a short flight time of 10 minutes, which can further be increased by battery improvements or efficient power management. Additionally, the drone system has weather limitation, which can be overcome by improving the system with advanced weatherproof material and designs.

In an embodiment, multiple specialized drones can be used for performing operations, wherein manual drone piloting requires extensive training and skills.

The proposed drone system offers several advantages over existing system, including: reduction in operational costs and complexity; enhanced safety and reliability during inspection tasks; faster and more effective emergency response capabilities; and single adaptive platform minimizing logistical and operational overhead.

The proposed drone system has several industrial applications, including: sewer and pipeline inspections; industrial facility safety monitoring; construction site surveillance and safety checks; environmental monitoring and analysis; and search and rescue operations in challenging environments.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A drone system (100), comprising:
a carbon fiber frame (102) having a central body portion and a plurality of radially extending hollow arms, each hollow arm terminating in a distal motor mount platform;
a plurality of motors (106) each mounted on a respective distal motor mount platform;
a protective cage (110) formed of arcuate struts joined at geodesic nodes, the protective cage (110) surrounding a plurality of propellers (104) and the motors (106), each motor (106) driving a corresponding propeller (104), and each geodesic node being received in a socket at a distal end of a corresponding hollow arm, and an elastomeric interface positioned between the geodesic nodes and the socket to absorb collision forces transmitted through the protective cage (110); and
a plurality of floats (112) attached to a lower portion of the carbon fiber frame (102), each floats (112) being secured by a keyed engagement into a recess of the carbon fiber frame (102) and locked by a transverse retention member, the floats (112) being symmetrically arranged relative to the carbon fiber frame (102) such that a center of buoyancy of the drone system (100) is aligned with a center of gravity, and wherein a lowest portion of the protective cage (110) is elevated above an upper surface of the floats (112) so that the propellers (104) remain clear of water when the drone system (100) is floating;
wherein each socket at the distal end of the hollow arm includes an annular seat lined with a compressible elastomer bushing, the geodesic nodes of the protective cage (110) being partially embedded in the annular seat, and a transverse pin passing through aligned bores in a distal arm and the geodesic nodes, whereby the protective cage (110) is restrained against axial withdrawal while being permitted limited angular displacement relative to the hollow arm under lateral impact; and wherein each floats (112) includes a rigid insert integrally molded within the float, the rigid insert being shaped as a trapezoidal dovetail projection received in a complementary dovetail recess of the carbon fiber frame (102), the recess being oriented such that vertical pull-out and rotational twisting of the floats (112) are mechanically prevented, and wherein a locking pin inserted transversely through the trapezoidal dovetail projection and a recess wall secures the floats (112) in place; and wherein the floats (112) extend below the lower surface of the carbon fiber frame (102) such that, when the drone system (100) is resting on a planar ground surface, the floats (112) act as landing supports and the protective cage (110) is elevated above the planar ground surface, thereby preventing contact of the propellers (104) with the planar ground surface during take-off and landing operations; and wherein each hollow arm of the carbon fiber frame (102) defines an internal conduit for routing motor phase wires, the internal conduit terminating in a sealed outlet adjacent the distal motor mount platform, the sealed outlet including an elastomeric grommet compressed into a chamfered aperture of the sealed outlet, the elastomeric grommet gripping the motor phase wires to provide strain relief and forming a seal to prevent moisture ingress during aquatic operation; and wherein the carbon fiber frame (102) defines a battery bay in the central body portion, the battery bay comprising a parallel guiding rails integrally bonded to a lower plate of the carbon fiber frame (102), the parallel guiding rails engaging complementary ridges on a casing of a battery (126a) to prevent lateral movement, and a spring-biased detent engaging a recess in the casing of the battery (126a) to positively restrain the battery against inertial ejection forces.

2. The drone system (100) of claim 1, wherein the protective cage (110) is mechanically removable by withdrawal of the transverse pin from the socket at the distal arm, such that the protective cage (110) can be replaced as a sacrificial component without detaching the motors (106) or floats (112); and wherein the floats (112) are arranged along both lateral sides of the carbon fiber frame (102) such that buoyancy forces generated by the floats (112) maintain the drone system (100) in an upright orientation on water, and wherein displacement of the drone system (100) from upright position results in self-righting due to realignment of a buoyant centerline with the center of gravity of the drone system (100).

3. The drone system (100) of claim 1, wherein the central body portion of the carbon fiber frame (102) houses a flight controller (114) mounted on elastomeric suspension posts, the elastomeric suspension posts being preloaded in compression such that oscillations transmitted from the motors (106) and propellers (104) through the carbon fiber frame (102) are attenuated before reaching inertial sensors of the flight controller (114); and wherein the protective cage (110) and the floats (112) are positioned relative to each other such that, when the drone system (100) floats on water, the protective cage (110) remains clear of waterline while continuing to enclose the propellers (104), thereby maintaining both collision protection and aquatic stability in a single integrated structure.

4. The drone system (100) of claim 1, wherein the protective cage (110) comprises arcuate struts intersecting at geodesic junctions, each junction including keyed interfaces between the struts to prevent relative slippage under compressive impact loads, thereby preserving geometric integrity of the protective cage (110) as an energy-dissipating structure; and wherein the arcuate struts of the protective cage (110) intersect at the geodesic junctions with complementary keyed ends, and wherein adhesive bonding or mechanical fastening at the complementary keyed ends resists both axial separation and torsional twisting of the struts relative to one another.

5. The drone system (100) of claim 1, wherein the socket formed at the distal end of the hollow arm includes opposed internal shoulders that laterally confine the geodesic nodes of the protective cage (110), and wherein the elastomeric interface positioned between the geodesic nodes and a socket wall deforms radially upon impact, thereby permitting the protective cage (110) to shift minutely relative to the hollow arm while the opposed internal shoulders mechanically restrain the geodesic nodes against circumferential displacement; and wherein each transverse pin securing the geodesic nodes within the socket is received in a through-bore of the geodesic nodes and a corresponding pair of aligned bores in the socket wall, and wherein the transverse pin is axially retained by frictional engagement with the socket wall, thereby enabling the transverse pin to serve both as a shear-resisting element locking the protective cage (110) to the hollow arm and as a pivot axis allowing limited angular articulation of the geodesic nodes within the elastomeric interface.

6. The drone system (100) of claim 1, wherein each floats (112) is keyed into its dovetail recess with surfaces inclined relative to a vertical pull, such that upward buoyant forces acting on the floats (112) drive the rigid insert further into the recess, thereby producing a self-locking effect that resists vertical withdrawal of the floats (112) during aquatic operation; and wherein the rigid insert of each floats (112) spans substantially across a width of the floats (112) and is encapsulated within a body of the float, and wherein the locking pin passes through both the rigid insert and an opposing recess wall, such that hydrodynamic loads applied to the floats (112) are transferred directly through the rigid insert into the carbon fiber frame (102) without imposing shear stresses on the float.

7. The drone system (100) of claim 1, wherein the battery bay of the carbon fiber frame (102) is open along one lateral side of the central body portion to permit sliding insertion of the battery (126a), and wherein the parallel guiding rails constrain the battery (126a) against vertical and lateral movement during insertion, and the spring-biased detent engages the recess in the battery casing once fully seated, thereby forming a sequential locking action that secures the battery (126a) both during flight and during water landings; and wherein the sealed outlet of the hollow arm is oriented downwardly relative to a propeller plane, and wherein the elastomeric grommet seated in the sealed outlet forms a continuous annular seal around the motor phase wires, such that gravity assists in preventing water ingress into the hollow arm during aquatic operation of the drone system (100).

8. The drone system (100) of claim 2, wherein the floats (112) are symmetrically arranged on opposite sides of the carbon fiber frame (102) with their longitudinal axes parallel to the longitudinal axes of the carbon fiber frame, and wherein the buoyancy forces generated by the floats (112) are positioned equidistantly from a vertical centerline of the drone system (100), such that any roll disturbance applied during flotation is counterbalanced by equal and opposite restoring forces from the floats (112), thereby achieving self-righting stability.

9. The drone system (100) of claim 3, wherein each elastomeric suspension post supporting the flight controller (114) is preloaded by clamping between the lower plate of the carbon fiber frame (102) and an underside of a housing of the flight controller, and wherein the preload ensures continuous compression of an elastomeric body, such that vibrational energy is dissipated through shear deformation of the elastomer suspension post while preventing resonant amplification of oscillations at a natural frequency of the flight controller (114).

10. The drone system (100) of claim 1, wherein the protective cage (110) and the floats (112) are cooperatively positioned such that, during a ground landing, the floats (112) act as primary contact members engaging the planar ground surface, while the protective cage (110) extends around a periphery of the propellers (104) without touching the ground, and wherein during aquatic operation, the floats (112) displace water to maintain the central body portion above a waterline while the protective cage (110) continues to enclose the propellers (104), thereby enabling a dual-environment landing system in which the floats (112) and protective cage (110) function together as integrated support and protection structures.

11. The drone system (100) of claim 1, wherein each hollow arm of the carbon fiber frame (102) simultaneously serves as a structural beam resisting torsional bending moments induced by a thrust of the motors (106) and as an enclosed conduit for routing motor phase wires, and wherein the routing of the motor phase wires within a neutral axis of the hollow arm prevents additional stress concentration on an arm wall, thereby ensuring that the hollow arm provide both structural rigidity and electrical protection without external cabling.

12. The drone system (100) of claim 1, wherein a plurality of battery bay guiding rails are mechanically bonded to an upper plate and a lower plate of the carbon fiber frame (102) and are further aligned parallel to a longitudinal axis of the central body portion, such that when the battery (126a) is engaged between the plurality of battery bay guiding rails, the rails and the battery casing together form a rigid cross-brace reinforcing the carbon fiber frame (102) against lateral deformation, thereby increasing torsional stiffness of the central body portion during high-thrust maneuvers.

13. The drone system (100) of claim 2, wherein the floats (112) are symmetrically distributed about both a longitudinal axes and a lateral axes of the carbon fiber frame (102), and wherein the buoyancy forces generated by the floats (112) cooperate with a lateral confinement of the protective cage (110) such that, when the drone system (100) tips laterally during flotation, the floats (112) provides a restoring buoyant force while the protective cage (110) provides a counter-balancing contact point against a water surface, thereby generating a self-righting torque without requiring actuation of the motors (106).

14. The drone system (100) of claim 1, wherein the protective cage (110) is configured as a sacrificial bumper assembly such that, upon repeated collision events, the arcuate struts deform elastically against the compressible elastomeric bushing seated in the socket of the hollow arm and progressively dissipate energy, and wherein the transverse retention pin are configured to be withdrawn to replace the protective cage (110) independently of the motors (106) and the floats (112), thereby enabling maintenance of the drone system (100) by modular replacement of the protective cage without disturbing flotation or propulsion subsystems; and wherein the carbon fiber frame (102) includes the hollow arm that are integrally bonded to the central body portion such that impact forces absorbed by the protective cage (110) at distal arm sockets are transmitted through the hollow arm into the central body portion, and wherein the floats (112) positioned beneath the central body portion absorb corresponding reaction loads during flotation, thereby forming a continuous load path from the protective cage (110) through the distal arm sockets and into the floats (112) for combined aerial and aquatic stability.

15. The drone system (100) of claim 3, wherein the elastomeric suspension posts supporting the flight controller (114) are positioned such that their axes are inclined relative to a vertical axis of the central body portion, and wherein inclined orientation causes vibrational loads transmitted through the carbon fiber frame (102) to be resolved into both shear and compression within the elastomer suspension, thereby increasing a damping efficiency of the elastomeric suspension posts across multiple vibration modes induced by the motors (106).

16. The drone system (100) of claim 4, wherein the arcuate struts of the protective cage (110) are arranged such that the intersections at geodesic junctions form closed triangular bracing patterns, and wherein each triangular bracing pattern spans across adjacent propeller discs, thereby distributing localized collision loads on one side of the protective cage (110) into both adjacent arms of the carbon fiber frame (102), thereby preventing localized collapse of the protective cage (110) during oblique impacts.

17. The drone system (100) of claim 1, wherein each floats (112) extends below the lower surface of the carbon fiber frame (102) and is configured with a flat lower bearing surface, the flat lower bearing surface being parallel to the lower plate of the central body portion, such that the floats (112) act as stabilizing skids during take-off and landing on ground surfaces, and wherein the complementary dovetail recess and locking pin ensure that ground impact loads are transmitted directly into the carbon fiber frame (102) without causing detachment of the floats (112); and wherein each electronic speed controller (108) is secured to an inner surface of the lower plate of the carbon fiber frame (102) in alignment with a corresponding hollow arm, the electronic speed controller (108) being mechanically fastened with a vibration-isolating mount and thermally coupled to the lower plate to dissipate heat, and wherein motor phase wires extend directly from the electronic speed controller (108) through an internal conduit of the hollow arm to the motors (106), thereby minimizing wire exposure and protecting electrical connections from mechanical strain.

18. The drone system (100) of claim 1, wherein the central body portion of the carbon fiber frame (102) further supports an imaging assembly comprising a thermal camera (120), a pilot camera (122), and an RGB camera (124), the thermal camera (120) and RGB camera (124) being mounted on a gimbal assembly secured to an underside of the lower plate, and the pilot camera (122) being fixed to a forward-facing bracket of the carbon fiber frame (102), wherein the floats (112) extend below the gimbal assembly to maintain clearance between the imaging assembly and a ground or water surface during landing, and the protective cage (110) extends forward of the pilot camera (122) to provide collision shielding without obstructing its field of view; and The drone system (100) of claim 1, wherein the central body portion of the carbon fiber frame (102) further houses a flight computer (116) including a processor (116a), the flight computer (116) being mechanically mounted on a heat-dissipating carrier plate secured to the lower plate of the carbon fiber frame (102), and wherein a LiDAR sensor (118) is fixed to an upper mounting bracket of the carbon fiber frame (102) in an elevated position relative to the propellers (104), the LiDAR sensor (118) being mechanically isolated from vibration of the carbon fiber frame (102) by an elastomeric pad, such that the flight computer (116) and the LiDAR sensor (118) are structurally integrated with the drone system (100) while remaining mechanically stabilized during aerial and aquatic operation.

19. The drone system (100) of claim 3, wherein the drone system (100) comprises a power system (126) including a battery (126a) retained in a bay defined by parallel guiding rails of the carbon fiber frame (102), a power module (126b) mechanically mounted adjacent to a battery bay on the lower plate, and a universal battery elimination circuit (126c) fixed to a circuit board carrier within the central body portion, wherein the parallel guiding rails, the power module (126b), and the universal battery elimination circuit (126c) are structurally integrated with the carbon fiber frame (102) such that inertial forces acting during abrupt acceleration or aquatic impact are distributed across the carbon fiber frame, thereby preventing localized deformation of the central body portion and maintaining stable electrical connectivity to the flight controller (114).
